(19) United States
(12) Patent Application Publication
(10) Pub. No.: US 2008/0083998 A1
(43) Pub. Date: Apr. 10, 2008

(54) MULTIPLE DRAW GAP LENGTH ORIENTATION PROCESS

(75) Inventors: William W. Merrill, White Bear Lake, MN (US); David D. Lindeman, Hudson, WI (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/539,304

(22) Filed: Oct. 6, 2006

(51) Int. Cl. B29D 7/01; B29D 11/00

(52) U.S. Cl. 264/1.34; 264/2.7

(57) ABSTRACT

A method of forming an optical film includes stretching a polymer film in first draw gap of a first length along a machine direction, at a first draw ratio; and further stretching the polymer film in second draw gap along a machine direction, wherein the step of stretching in the first draw gap is isolated from the step of stretching in the second draw gap.

### TECHNICAL FIELD

This disclosure relates generally to optical films and methods for making optical films.

### BACKGROUND

Polymeric optical films are used in a wide variety of applications such as reflective polarizers. Such reflective polarizer films are used, for example, in conjunction with backlights in liquid crystal displays. A reflective polarizing film can be placed between the user and the backlight to recycle polarized light that would be otherwise absorbed, and thereby increasing brightness. These polymeric optical films often have high reflectivity, while being lightweight and resistant to breakage. Thus, the films are suited for use as reflectors and polarizers in compact electronic displays, such as liquid crystal displays (LCDs) placed in mobile telephones, personal data assistants, portable computers, desktop monitors, and televisions, for example.

In commercial processes, optical films made from polymeric materials or blends of materials are typically extruded from a die or cast from solvent. The extruded or cast film is then stretched to create and/or enhance birefringence in at least some of the materials. The materials and the stretching protocol may be selected to produce an optical film such as a reflective optical film, for example, a reflective polarizer or a mirror.

To reduce defects, such as die lines, and provide a film having a substantially uniform thickness, optical films such as reflective polarizing films, have been extruded from relatively narrow dies and then stretched in a crossweb or film width direction (referred to herein as the transverse direction or TD). Usually, such reflective polarizing films have a block axis along the TD.

In some applications, it is advantageous to laminate a reflective polarizing film to a dichroic polarizing film to make, for example, a film construction for a liquid crystal display (LCD). When supplied in roll form, the dichroic polarizing film usually has a block axis along the length of the roll (MD). The block axis in the dichroic polarizing film and the reflective polarizing film discussed above are perpendicular to one another. To make the laminate film construction for an optical display, the reflective polarizing film must first be cut into sheets, rotated 90°, and then laminated to the dichroic polarizing film. This laborious process makes it difficult to produce laminated film constructions in roll form on a commercial scale and increases the cost of the final product.

Thus, there is a need for a process for making a reflective optical film that is oriented in the MD. In one embodiment, the process results in a reflective polarizing film.

### SUMMARY

A method of forming an optical film includes stretching a polymer film in first draw gap of a first length along a machine direction, at a first draw ratio; and further stretching the polymer film in second draw gap along a machine direction, wherein the step of stretching in the first draw gap is isolated from the step of stretching in the second draw gap.

The above summary is not intended to describe each illustrated embodiment or every implementation of the present invention. The figures and the detailed description which follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIGS. 1A and 1B illustrate optical films.

FIG. 2 illustrates a blended optical film.

FIG. 3A is a schematic diagram of a film line using a length orienter.

FIG. 3B illustrates a portion of an embodiment of a film line using multiple draw gaps.

FIG. 3C is a schematic diagram of one embodiment of a length orienter threading system.

FIG. 3D is a schematic diagram of another embodiment of a length orienter threading system.

FIG. 4 is a schematic illustration of the deformation of a unit of film in a one-directional stretching process with width constraint.

FIG. 5 is a schematic illustration of the deformation of a unit of film in a uniaxial stretching process.

FIG. 6 is a graph illustrating uniaxial character vs. draw ratio at low and moderate L/W aspect ratios.

FIG. 7 illustrates the crossweb thickness profile for a series of model films with various L/W aspect ratios, of initially uniform 0.030″ (0.76 mm) thickness drawn to approximately five times in MD.

FIG. 8 illustrates a laminate construction in which a first optical film is attached to a second optical film.

FIGS. 9A-9B are cross-sectional views of exemplary constructions made according to the present disclosure.

FIGS. 10A-10C are cross-sectional views of exemplary constructions made according to the present disclosure.

FIG. 11 is a cross-sectional view of an exemplary construction made according to the present disclosure.

FIG. 12 is a representative temperature profile in one embodiment of a dual draw gap scenario.

FIG. 13A shows the approximate progress of the draw ratio with MD position in accord with a single gap model simulation similar to that presented in FIG. 7.

FIG. 13B illustrates a method for approximately mapping a single draw gap baseline process to a multiple draw gap process by dividing the draw gap into parts.

FIG. 14 shows the rate of change of Hencky strain with MD progress in accord with the same model as FIGS. 13A and 13B.

### DETAILED DESCRIPTION

The present disclosure is directed to making optical films. Optical films differ from other films, for example, in that they are required to have uniformity and sufficient optical quality designed for a particular end use application, for example, optical displays. For the purposes of this application, sufficient quality for use in optical displays means that the films, when mounted in the desired application, following all processing steps, are substantially free of visible defects, e.g., have substantially no color streaks or surface ridges running in the MD when viewed by an unaided human eye. In addition, an exemplary embodiment of an optical quality film of the present disclosure has a caliper variation over the useful film area of less than 5% (±2.5%), preferably less than 3.5% (±1.75%), less than 3% (±1.5%), and more preferably less than 1% (±0.5%) of the average thickness of the film.

In one embodiment of the present disclosure, a process used to make reflective polarizing films uses a die constructed to make an extruded film that is then stretched along the downweb direction in a length orienter (LO), which is an arrangement of rollers rotating at differing speeds selected to stretch the film along the film length direction, which also may be referred to as the machine direction (MD). In one embodiment, a film produced using an LO, which may be a reflective polarizing film, has a block axis (i.e., the axis characterized by a lower transmission of light polarized along that direction than that along an orthogonal direction) typically approximately aligned within about 10 degrees, and preferably approximately aligned within about 5 degrees, of the MD. In another embodiment, the film, which may be a reflective polarizing film, has a block axis typically approximately aligned within about 10 degrees, and preferably approximately aligned within about 5 degrees, of the TD.

The present disclosure is directed to methods for making optical films, such as reflective polarizing films having a polarizing axis along their length (along the MD). The reflective polarizing films may include, without limitation, multilayer reflective polarizing films and diffusely reflective polarizing optical films. In some exemplary embodiments, the reflective polarizing films may be advantageously laminated to other optical films in roll-to-roll processes. In the context of the present disclosure, a reflective polarizer preferentially reflects light of a first polarization and preferentially transmits light of a second, different polarization. Preferably, a reflective polarizer reflects a majority of light of a first polarization and transmits a majority of light of a second, different polarization.

The following description should be read with reference to the drawings, in which like elements in different drawings are numbered in like fashion. The drawings, which are not necessarily to scale, depict selected illustrative embodiments and are not intended to limit the scope of the disclosure. Although examples of construction, dimensions, and materials are illustrated for the various elements, those skilled in the art will recognize that many of the examples provided have suitable alternatives that may be utilized.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a,” “an,” and “the” encompass embodiments having plural referents, unless the content clearly dictates otherwise. For example, reference to “a film” encompasses embodiments having one, two or more films. As used in this specification and the appended claims, the term “or” is generally employed in its sense including “and/or” unless the content clearly dictates otherwise.

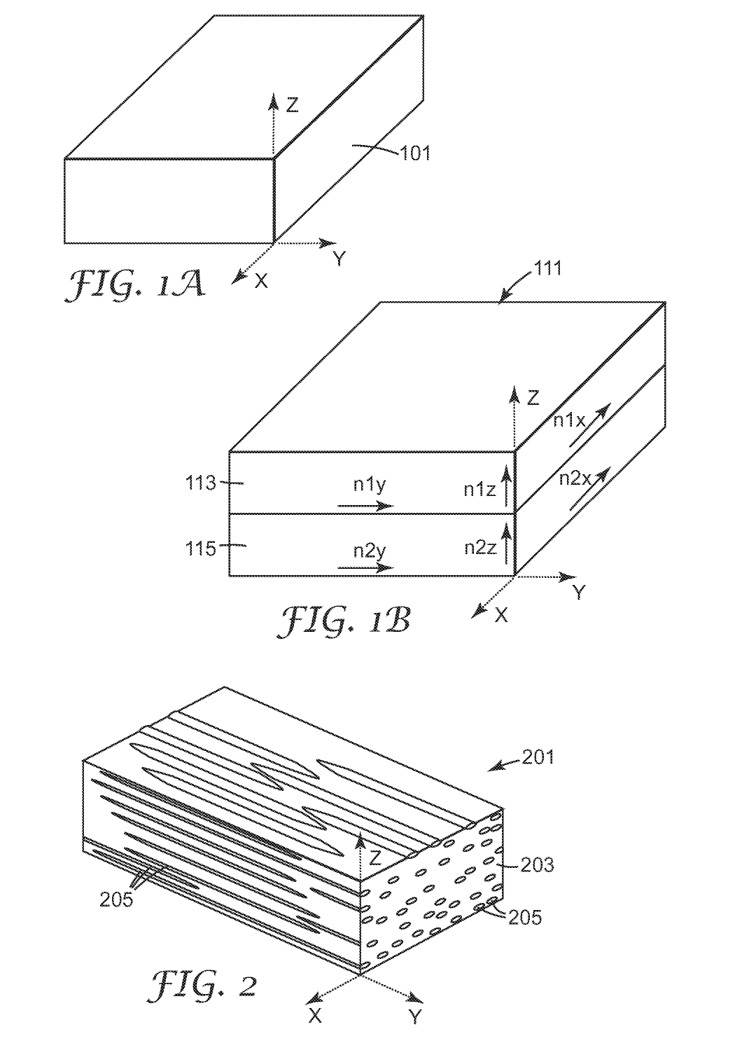

FIG. 1A illustrates a portion of an optical film construction 101 that may be formed in the processes described below. The depicted optical film 101 may be described with reference to three mutually orthogonal axes x, y and z. In the illustrated embodiment, two orthogonal axes x and y are in the plane of the film 101 (in-plane, or x and y axes) and a third axis (z-axis) extends in the direction of the film thickness. In some exemplary embodiments, the optical film 101 includes at least two different materials, a first material and a second material, which are optically interfaced (e.g., two materials combine to cause an optical effect such as reflection, scattering, transmission, etc.). In some instances, the materials are arranged in alternating layers. In other instances, the materials form interdispersed phases (e.g., one continuous phase and another phase dispersed in that continuous matrix; or two bi-continuous phases) within a monolithic layer of the blended materials.

In typical embodiments of the present disclosure, one or both materials are polymeric. The first and second materials may be selected to produce a desired mismatch of refractive indices in a direction along at least one axis of the film 101. The materials may also be selected to produce a desired match of refractive indices in a direction along at least one axis of the film 101 perpendicular to a direction along which the refractive indices are mismatched. At least one of the materials is subject to developing birefringence under certain conditions. The materials used in the optical film are preferably selected to have sufficiently similar rheology (e.g., visco-elasticity) to meet the requirements of a coextrusion process, although cast films can also be used. In other exemplary embodiments, the optical film 101 may be composed of only one material or a miscible blend of two or more materials.

The optical film 101 can be a result of a film processing method that may include drawing or stretching the film. Drawing a film under different processing conditions may result in widening of the film without strain-induced orientation, widening of the film with strain-induced orientation, or strain-induced orientation of the film with lengthening. Strain can also be introduced by a compression step, such as by calendering. Generally, the forming process can include either type of orientation (extension or compression-type) or it can include both; one embodiment includes a step imparting both compression and extension simultaneously. The induced molecular orientation may be used, for example, to change the refractive index of an affected material in the direction of the draw. The amount of molecular orientation induced by the draw can be controlled based on the desired properties of the film, as described more fully below.

The term “birefringent” means that the indices of refraction in orthogonal x, y, and z directions are not all the same. For the polymer layers described herein, the axes are selected so that x and y axes are in the plane of the layer and the z axis corresponds to the thickness or height of the layer. The principal axes refer to the directions where the indices of refraction are at the maximum and minimum values. The term “in-plane birefringence” is understood to be the difference between the principal in-plane indices (nₓ and n_{y}) of refraction. The term “out-of-plane birefringence” is understood to be the difference between one of the principal in-plane indices (nₓ or n_{y}) of refraction and the principal out-of-plane index of refraction n_{z}.

It is useful to compare the relative differences between the smallest out-of-plane birefringence as would be related to the various pass state matching conditions at various angles of incidence and the in-plane birefringence to assess the relative optical power of a multi-layer polarizer at normal incidence versus its color non-uniformity or pass state reflection at off-normal axis. The term “relative birefringence” is understood to be approximately the ratio of the smallest out-of-plane birefringence to the in-plane birefringence. More precisely, the relative birefringence is calculated as the ratio of the absolute value of the smallest out-of-plane birefringence determined by the out-of-plane refractive index n_{z} and the in-plane principal index of refraction nearest to it in value, to the absolute value of the difference between the average of this out-of-plane refractive index n_{z} and the in-plane principal index of refraction nearest to it in value and the other in-plane principal refractive index. The principal in-plane directions typically align in approximately the crossweb/transverse direction (TD) and the downweb/machine direction (MD), especially in the center of the film in a cross-web symmetric process. The principal out-of-plane direction may approximate the normal direction (ND). For example, if the draw is principally along the x direction, then near the center of the film in the cross-web direction, the relative birefringence is calculated as |n_{y}−n_{z}| divided by |nₓ−(n_{y}+n_{z})/2|. Useful values of relative birefringence are typically between 0.10 and 0.20, although lower values may also be desired. All birefringence and index of refraction values are reported for 632.8 nm light unless otherwise indicated.

A birefringent, oriented layer typically exhibits a difference between the transmission and/or reflection of incident light rays having a plane of polarization parallel to the oriented direction (i.e., stretch direction) and light rays having a plane of polarization parallel to a transverse direction (i.e., a direction orthogonal to the stretch direction). For example, when an orientable polyester film is stretched along the x axis, the typical result is that nₓ≠n_{y}, where nₓ and n_{y} are the indices of refraction for light polarized in a plane parallel to the “x” and “y” axes, respectively. The degree of alteration in the index of refraction along the stretch direction will depend on factors such as the amount of stretching, the stretch rate, the temperature of the film during stretching, the thickness of the film, the variation in the film thickness, and the composition of the film.

It will be appreciated that the refractive index in a material is a function of wavelength (i.e., materials typically exhibit dispersion). Therefore, the optical requirements on refractive index are also a function of wavelength. The index ratio of two optically interfaced materials can be used to calculate the reflective power of the two materials. The absolute value of the refractive index difference between the two materials for light polarized along a particular direction divided by the average refractive index of those materials for light polarized along the same direction is descriptive of the film's optical performance. This will be called the normalized refractive index difference.

In a reflective polarizer, it is generally desirable that the normalized difference, if any, in mismatched in-plane refractive refractive indices, e.g., in-plane (MD) direction, be at least about 0.06, more preferably at least about 0.09, and even more preferably at least about 0.11 or more. More generally, it is desirable to have this difference as large as possible without significantly degrading other aspects of the optical film. It is also generally desirable that the normalized difference, if any, in matched in-plane refractive indices, e.g., in the in-plane (TD) direction, be less than about 0.06, more preferably less than about 0.03, and most preferably less than about 0.01. Similarly, it can be desirable that any normalized difference in refractive indices in the thickness direction of a polarizing film, e.g., in the out-of-plane (ND) direction, be less than about 0.11, less than about 0.09, less than about 0.06, more preferably less than about 0.03, and most preferably less than about 0.01. In certain instances it may desirable to have a controlled mismatch in the thickness direction of two adjacent materials in a multilayer stack. The influence of the z-axis refractive indices of two materials in a multilayer film on the optical performance of such a film are described more fully in U.S. Pat. No. 5,882,774, entitled Optical Film; U.S. Pat. No. 6,531,230, entitled “Color Shifting Film;” and U.S. Pat. No. 6,157,490, entitled “Optical Film with Sharpened Bandedge,” the contents of which are incorporated herein by reference.

Exemplary embodiments of the present disclosure also may be characterized by “an effective orientation axis,” which is the in-plane direction in which the refractive index has changed the most as a result of strain-induced orientation. For example, the effective orientation axis typically coincides with the block axis of a polarizing film, reflective or absorbing. In general, there are two principal axes for the in-plane refractive indices, which correspond to maximum and minimum refractive index values. For a positively birefringent material, in which the refractive index tends to increase for light polarized along the main axis or direction of stretching, the effective orientation axis coincides with the axis of maximum in-plane refractive index. For a negatively birefringent material, in which the refractive index tends to decrease for light polarized along the main axis or direction of stretching, the effective orientation axis coincides with the axis of minimum in-plane refractive index.

The optical film 101 is typically formed using two or more different materials. In some exemplary embodiments, the optical film of the present disclosure includes only one birefringent material. In other exemplary embodiments, the optical film of the present disclosure includes at least one birefringent material and at least one isotropic material. In yet other exemplary embodiments, the optical film includes a first birefringent material and a second birefringent material. In some such exemplary embodiments, the in-plane refractive indices of both materials change similarly in response to the same process conditions. In one embodiment, when the film is drawn, the refractive indices of the first and second materials should both increase for light polarized along the direction of the draw (e.g., the MD) while decreasing for light polarized along a direction orthogonal to the stretch direction (e.g., the TD). In another embodiment, when the film is drawn, the refractive indices of the first and second materials should both decrease for light polarized along the direction of the draw (e.g., the MD) while increasing for light polarized along a direction orthogonal to the stretch direction (e.g., the TD). In some embodiments, where one, two or more birefringent materials are used in an oriented optical film according to the present disclosure, the effective orientation axis of each birefringent material is aligned along the MD.

When the orientation resulting from a combination of process steps causes a match of the refractive indices of the two materials in one in-plane direction and a substantial mismatch of the refractive indices in the other in-plane direction, the film is especially suited for fabricating an optical polarizer. The matched direction forms a transmission (pass) direction for the polarizer and the mismatched direction forms a reflection (block) direction. Generally, the larger the mismatch in refractive indices in the reflection direction and the closer the match in the transmission direction, the better the performance of the polarizer.

One class of polymers useful in creating polarizer films is polyesters. One example of a polyester-based polarizer includes a stack of polyester layers of differing compositions. One configuration of this stack of layers includes a first set of birefringent layers and a second set of layers with an isotropic index of refraction. The second set of layers alternates with the birefringent layers to form a series of interfaces for reflecting light.

The properties of a given polyester are typically determined by the monomer materials utilized in the preparation of the polyester. A polyester is often prepared by reactions of one or more different carboxylate monomers (e.g., compounds with two or more carboxylic acid or ester functional groups) with one or more different glycol monomers (e.g., compounds with two or more hydroxy functional groups). Each set of polyester layers in the stack typically has a different combination of monomers to generate the desired properties for each type of layer. In many embodiments, the multilayer reflective polarizers are formed from polymer layers made from polyesters having naphthalate subunits, including, for example, homopolymers or copolymers of polyethylene naphthalate.

FIG. 1B illustrates a multilayer optical film 111 that includes a first layer of a first material 113 disposed (e.g., by coextrusion) on a second layer of a second material 115. Either or both of the first and second materials may be positively or negatively birefringent. While only two layers are illustrated in FIG. 1B and generally described herein, the process is applicable to multilayer optical films having up to hundreds or thousands or more of layers made from any number of different materials. The multilayer optical film 111 or the optical film 101 may include additional layers. The additional layers may be optical, e.g., performing an additional optical function, or non-optical, e.g., selected for their mechanical or chemical properties, or a particular layer may be performing both functions. As discussed in U.S. Pat. No. 6,179,948, incorporated herein by reference, these additional layers may be orientable under the process conditions described herein, and may contribute to the overall optical and/or mechanical properties of the film.

The optical layers 113, 115 and, optionally, one or more of the non-optical layers are typically placed one on top of the other to form a stack of layers, as shown in FIG. 1B. The optical layers 113, 115 are arranged as alternating optical layer pairs where each optical layer pair includes a first polymer layer 113 and a second polymer layer 115, as shown in FIG. 1B, to form a series of interfaces between layers with different optical properties. The interface between the two different optical layers (e.g., first and second layers) forms a light reflection plane, if the indices of refraction of the first and second polymer layers are different in at least one direction, e.g., at least one of x, y, and z directions.

Light polarized in a plane parallel to the direction in which the indices of refraction of the two layers are approximately equal will be substantially transmitted. Light polarized in a plane parallel to the direction in which the two layers have different indices will be at least partially reflected. The reflectivity can be increased by increasing the number of layers or by increasing the difference in the indices of refraction between the first and second layers. Generally, multilayer optical films can have 2 to 5000 optical layers, or 25 to 2000 optical layers, or 50 to 1500 optical layers, or 75 to 1000 optical layers. A film having a plurality of layers can include layers with different optical thicknesses to increase the reflectivity of the film over a range of wavelengths. For example, a film can include pairs of layers that are individually tuned (for normally incident light, for example) to achieve optimal reflection of light having particular wavelengths. It should further be appreciated that, although only a single multilayer stack may be described, the multilayer optical film can be made from multiple stacks that are subsequently combined to form the film. Other considerations relevant to making multilayer reflective polarizers are described, for example, in U.S. Pat. No. 5,882,774 to Jonza et al., the disclosure of which is hereby incorporated by reference herein to the extent it is not inconsistent with the present disclosure.

In many embodiments, the optical films are thin. Suitable films include films of varying thickness and particularly include films less than 15 mils (about 380 micrometers) thick, or less than 10 mils (about 250 micrometers) thick, or less than 7 mils (about 180 micrometers) thick, or less than 2 mils (about 51 micrometers) thick.

To produce a reflective polarizer, for example, it is generally desirable that the difference if any, in the matched refractive indices, e.g., in the in-plane principal transverse direction (TD), be less than about 0.05, more preferably less than about 0.02, and most preferably less than about 0.01. In the mismatched direction e.g., in-plane (MD) direction, it is generally desirable that the difference in refractive indices be at least about 0.06, more preferably greater than about 0.09, and even more preferably greater than about 0.11. More generally, it is desirable to have this difference as large as possible without significantly degrading other aspects of the optical film.

One approach to forming a reflective polarizer uses a first material that becomes birefringent as a result of processing according to the present disclosure and a second material having an index of refraction which remains substantially isotropic, i.e., does not develop appreciable amounts of birefringence, during the draw process. In some exemplary embodiments, the second material is selected to have a refractive index which matches the non-drawn in-plane refractive index of the first material subsequent to the draw.

Optical power may be exhibited over a range of any spectral band, e.g. infrared, ultraviolet or visible, for example. In many embodiments, the multilayer optical film exhibits an optical power in a band range, eg. from 500 to 800 nm or from 600 to 700 nm, for example. The optical power may be calculated with respect to a fixed band range or with respect to a relative band range as set forth by the internal layer structure of the optical film. When a relative band edge is chosen, one may choose the 50% transmission band edge, i.e. where 50% of the light is transmitted. Optical power can then be calculated by taking dark state on-axis transmission measurements (% T) (with a spectrophotometer such as, for example a Lambda 19 spectrophotometer) between the 50% transmission band edges and converting it to optical density (OD) units by the following equation:

OD=−LOG[% T/100]

The area under this OD unit curve is optical power.

For a polarizer embodiment in which the indices of two polymer layers are matched in the non-stretched in-plane direction and not matched in the stretched direction, optical power is a measure proportional to the refractive index difference between the first polymer layer material and the second polymer layer material, in the stretch direction. Since the effective refractive index difference between the first polymer layer material and the second polymer layer material may not be easy to measure, optical power calculations are a convenient means to determine the relative birefringence between layers in multilayer optical films, provided the number of layer pairs, and materials used are known. Optical power is proportional to the number of optical layer pairs in a specific multilayer optical film; thus, optical power of a specific film can be divided by the number of optical layer pairs to obtain an (average) optical power per optical layer pair. In many embodiments, the multilayer optical films have an optical power in a range from 1.2 to 2.0 per optical layer pair, or from 1.4 to 1.7 per optical layer pair. Thus, one illustrative multilayer optical film having 825 layers or about 411 layer pairs have an optical power in a range from 500 to 800, or from 600 to 700.

Materials suitable for use in the optical films of FIGS. 1A, 1B are discussed in, for example, U.S. Pat. No. 5,882,774, which is incorporated herein by reference. Suitable materials include polymers such as, for example, polyesters, copolyesters and modified copolyesters. In this context, the term “polymer” will be understood to include homopolymers and copolymers, as well as polymers or copolymers that may be formed in a miscible blend, for example, by co-extrusion or by reaction, including, for example, transesterification. The terms “polymer” and “copolymer” include both random and block copolymers. Polyesters suitable for use in some exemplary optical films of the optical bodies constructed according to the present disclosure generally include carboxylate and glycol subunits and can be generated by reactions of carboxylate monomer molecules with glycol monomer molecules. Each carboxylate monomer molecule has two or more carboxylic acid or ester functional groups and each glycol monomer molecule has two or more hydroxy functional groups. The carboxylate monomer molecules may all be the same or there may be two or more different types of molecules. The same applies to the glycol monomer molecules. Also included within the term “polyester” are polycarbonates derived from the reaction of glycol monomer molecules with esters of carbonic acid.

Suitable carboxylate monomer molecules for use in forming the carboxylate subunits of the polyester layers include, for example, 2,6-naphthalene dicarboxylic acid and isomers thereof, terephthalic acid; isophthalic acid; phthalic acid; azelaic acid; adipic acid; sebacic acid; norbornene dicarboxylic acid; bi-cyclooctane dicarboxylic acid; 1,6-cyclohexane dicarboxylic acid and isomers thereof, t-butyl isophthalic acid, trimellitic acid, sodium sulfonated isophthalic acid; 4,4′-biphenyl dicarboxylic acid and isomers thereof, and lower alkyl esters of these acids, such as methyl or ethyl esters. The term “lower alkyl” refers, in this context, to C1-C10 straight-chained or branched alkyl groups.

Suitable glycol monomer molecules for use in forming glycol subunits of the polyester layers include ethylene glycol; propylene glycol; 1,4-butanediol and isomers thereof, 1,6-hexanediol; neopentyl glycol; polyethylene glycol; diethylene glycol; tricyclodecanediol; 1,4-cyclohexanedimethanol and isomers thereof, norbornanediol; bicyclo-octanediol; trimethylol propane; pentaerythritol; 1,4-benzenedimethanol and isomers thereof, bisphenol A; 1,8-dihydroxy biphenyl and isomers thereof, and 1,3-bis(2-hydroxyethoxy)benzene.

An exemplary polymer useful in the optical films of the present disclosure is polyethylene naphthalate (PEN), which can be made, for example, by reaction of naphthalene dicarboxylic acid with ethylene glycol. Polyethylene 2,6-naphthalate (PEN) is frequently chosen as a first polymer. PEN has a large positive stress optical coefficient, retains birefringence effectively after stretching, and has little or no absorbance within the visible range. PEN also has a large index of refraction in the isotropic state. Its refractive index for polarized incident light of 550 nm wavelength increases when the plane of polarization is parallel to the stretch direction from about 1.64 to as high as about 1.9. Increasing molecular orientation increases the birefringence of PEN. The molecular orientation may be increased by stretching the material to greater stretch ratios and holding other stretching conditions fixed. Other semicrystalline polyesters suitable as first polymers include, for example, polybutylene 2,6-naphthalate (PBN), polyhexamethylene naphthalate (PHN), polyethylene terephthalate (PET), polybutylene terephthalate (PBT), polyhexamethylene terephthalate (PHT), and copolymers thereof.

In an exemplary embodiment, a second polymer of the second optical layers is chosen so that in the finished film, the refractive index, in at least one direction, differs significantly from the index of refraction of the first polymer in the same direction. Because polymeric materials are typically dispersive, that is, their refractive indices vary with wavelength, these conditions should be considered in terms of a particular spectral bandwidth of interest. It will be understood from the foregoing discussion that the choice of a second polymer is dependent not only on the intended application of the multilayer optical film in question, but also on the choice made for the first polymer, as well as processing conditions.

Other materials suitable for use in optical films and, particularly, as a first polymer of the first optical layers, are described, for example, in U.S. Pat. Nos. 6,352,761, 6,352,762 and 6,498,683 and U.S. patent applications Ser. Nos. 09/229724 and 09/399531, which are incorporated herein by reference. Another polyester that is useful as a first polymer is a coPEN having carboxylate subunits derived from 90 mol % dimethyl naphthalene dicarboxylate and 10 mol % dimethyl terephthalate and glycol subunits derived from 100 mol % ethylene glycol subunits and an intrinsic viscosity (IV) of 0.48 dL/g. The index of refraction of that polymer is approximately 1.63. The polymer is herein referred to as low melt PEN (90/10). Another useful first polymer is a PET having an intrinsic viscosity of 0.74 dL/g, available from Eastman Chemical Company (Kingsport, Tenn.). Non-polyester polymers are also useful in creating polarizer films. For example, polyether imides can be used with polyesters, such as PEN and coPEN, to generate a multilayer reflective mirror. Other polyester/non-polyester combinations, such as polyethylene terephthalate and polyethylene (e.g., those available under the trade designation Engage 8200 from Dow Chemical Corp., Midland, Mich.), can be used.

The second optical layers can be made from a variety of polymers having glass transition temperatures compatible with that of the first polymer and having a refractive index similar to one refractive index plane of the first polymer. Examples of other polymers suitable for use in optical films, and particularly in the second optical layers or minor phases in blended optical films, include vinyl polymers and copolymers made from monomers such as vinyl naphthalenes, styrene, styrene acrylonitrile, maleic anhydride, acrylates, and methacrylates. Examples of such polymers include polyacrylates, polymethacrylates, such as poly (methyl methacrylate) (PMMA), and isotactic or syndiotactic polystyrene. Other polymers include condensation polymers such as polysulfones, polyamides, polyurethanes, polyamic acids, and polyimides. In addition, the second optical layers can be formed from polymers or copolymers of, or blends of copolyesters and polycarbonates such as, SA115 from Eastman, Xylex from GE, or Makroblend from Bayer.

Other exemplary suitable polymers, especially for use in the second optical layers, include homopolymers of polymethylmethacrylate (PMMA), such as those available from Ineos Acrylics, Inc., Wilmington, Del., under the trade designations CP71 and CP80, or polyethyl methacrylate (PEMA), which has a lower glass transition temperature than PMMA. Additional second polymers include copolymers of PMMA (coPMMA), such as a coPMMA made from 75 wt % methylmethacrylate (MMA) monomers and 25 wt % ethyl acrylate (EA) monomers, (available from Ineos Acrylics, Inc., under the trade designation Perspex CP63), a coPMMA formed with MMA comonomer units and n-butyl methacrylate (nBMA) comonomer units, or a blend of PMMA and poly(vinylidene fluoride) (PVDF) such as that available from Solvay Polymers, Inc., Houston, Tex. under the trade designation Solef 1008. Additonal copolymers useful as second optical layers or minor phases in blends include styrene acrylate copolymers such as NAS30 from Noveon and MS600 from Sanyo Chemicals.

Yet other suitable polymers, especially for use in the second optical layers, include polyolefin copolymers such as poly(ethylene-co-octene) (PE-PO) available from Dow-Dupont Elastomers under the trade designation Engage 8200, poly(propylene-co-ethylene) (PPPE) available from Fina Oil and Chemical Co., Dallas, Tex., under the trade designation Z9470, and a copolymer of atatctic polypropylene (aPP) and isotatctic polypropylene (iPP) available from Huntsman Chemical Corp., Salt Lake City, Utah, under the trade designation Rexflex W111. The optical films can also include, for example in the second optical layers, a functionalized polyolefin, such as linear low density polyethylene-g-maleic anhydride (LLDPE-g-MA) such as that available from E.I. duPont de Nemours & Co., Inc., Wilmington, Del., under the trade designation Bynel 4105.

Exemplary combinations of materials in the case of polarizers include PEN/co-PEN, polyethylene terephthalate (PET)/co-PEN, PEN/sPS, PEN/Eastar, and PET/Eastar, where “co-PEN” refers to a copolymer or blend based upon naphthalene dicarboxylic acid (as described above) and Eastar is polycyclohexanedimethylene terephthalate commercially available from Eastman Chemical Co. Exemplary combinations of materials in the case of mirrors include PET/coPMMA, PEN/PMMA or PEN/coPMMA, PET/ECDEL, PEN/ECDEL, PEN/sPS, PEN/THV, PEN/co-PET, and PET/coPMMA, where “co-PET” refers to a copolymer or blend based upon terephthalic acid (as described above), ECDEL is a thermoplastic polyester commercially available from Eastman Chemical Co., and THV is a fluoropolymer commercially available from 3M Company. PMMA refers to polymethyl methacrylate and PETG refers to a copolymer of PET employing a second glycol comonomer (cyclohexanedimethanol). sPS refers to syndiotactic polystyrene. The film may optionally be treated by applying any or all of corona treatments, primer coatings or drying steps in any order to enhance its surface properties for subsequent lamination steps.

In another embodiment, the optical film can be or can include a reflective polarizer that is a blend optical film. In a typical blend film, a blend (or mixture) of at least two different materials is used. A mismatch in refractive indices of the two or more materials along a particular axis can be used to cause incident light that is polarized along that axis to be substantially scattered, resulting in a significant amount of diffuse reflection of that light. Incident light that is polarized in the direction of an axis in which the refractive indices of the two or more materials are matched will be substantially transmitted or at least transmitted with a much lesser degree of scattering. By controlling the relative refractive indices of the materials, among other properties of the optical film, a diffusely reflective polarizer may be constructed. Such blend films may assume a number of different forms. For example, the blend optical film may include one or more disperse phases within one or more continuous phases, or co-continuous phases. The general formation and optical properties of various blend films are further discussed in U.S. Pat. Nos. 5,825,543 and 6,111,696, the disclosures of which are incorporated by reference herein.

FIG. 2 illustrates an embodiment of the present disclosure formed of a blend of a first material and a second material that is substantially immiscible in the first material. In FIG. 2, an optical film 201 is formed of a continuous (matrix) phase 203 and a disperse (discontinuous) phase 207. The continuous phase may comprise the first material and the second phase may comprise the second material. The optical properties of the film may be used to form a diffusely reflective polarizing film. In such a film, the refractive indices of the continuous and disperse phase materials are substantially matched along one in-plane axis and are substantially mismatched along another in-plane axis. Generally, one or both of the materials are capable of becoming positively birefringent as a result of calendering or stretching under the appropriate conditions. In the diffusely reflective polarizer, such as that shown in FIG. 2, it is desirable to match the refractive indices of the materials in the direction of one in-plane axis of the film as close as possible while having as large of a refractive indices mismatch as possible in the direction of the other in-plane axis.

If the optical film 201 is a blend film including a disperse phase 205 and a continuous phase 203 as shown in FIG. 2 or a blend film including a first co-continuous phase and a second co-continuous phase, many different materials may be used as the continuous or disperse phases. Such materials may include inorganic materials such as silica-based polymers, organic materials such as liquid crystals, and polymeric materials, including monomers, copolymers, grafted polymers, and mixtures or blends thereof. The materials selected for use as the continuous and disperse phases or as co-continuous phases in the blend optical film having the properties of a diffusely reflective polarizer may, in some exemplary embodiments, include at least one optical material that is orientable under the processing conditions to introduce birefringence and at least one material that does not appreciably orient under the processing conditions and does not develop an appreciable amount of birefringence. Other exemplary materials useful as the minor or disperse phase in a blended optical film include negatively birefringent polymers such as syndiotactic polystyrene (sPS) and syndiotactic polyvinyl naphthalene.

Details regarding materials selection for blend films are set forth in U.S. Pat. Nos. 5,825,543 and 6,590,705, both incorporated by reference. Suitable materials for the continuous phase (which also may used in the disperse phase in certain constructions or in a co-continuous phase) may be amorphous, semicrystalline, or crystalline polymeric materials, including materials made from monomers based on carboxylic acids such as isophthalic, azelaic, adipic, sebacic, dibenzoic, terephthalic, 2,7-naphthalene dicarboxylic, 2,6-naphthalene dicarboxylic, cyclohexanedicarboxylic, and bibenzoic acids (including 4,4′-bibenzoic acid), or materials made from the corresponding esters of the aforementioned acids (i.e., dimethylterephthalate). Of these, 2,6-polyethylene naphthalate (PEN), copolymers of PEN and polyethylene terepthalate (PET), PET, polypropylene terephthalate, polypropylene naphthalate, polybutylene terephthalate, polybutylene naphthalate, polyhexamethylene terephthalate, polyhexamethylene naphthalate, and other crystalline naphthalene dicarboxylic polyesters. PEN, PET, and their copolymers are especially preferred because of their strain induced birefringence, and because of their ability to remain permanently birefringent at elevated environmental temperatures.

Suitable materials for the second polymer in some film constructions include materials that are substantially non-positively birefringent when oriented under the conditions used to generate the appropriate level of birefringence in the first polymeric material. Suitable examples include polycarbonates (PC) and copolycarbonates,polystyrene-polymethylmethacrylate copolymers (PS-PMMA), PS-PMMA-acrylate copolymers such as, for example, those available under the trade designations MS 600 (50% acrylate content) from Sanyo Chemical Indus., Kyoto, Japan, NAS 21 (20% acrylate content) and NAS 30 (30% acrylate content) from Nova Chemical, Moon Township, Pa., polystyrene maleic anhydride copolymers such as, for example, those available under the trade designation DYLARK from Nova Chemical, acrylonitrile butadiene styrene (ABS) and ABS-PMMA, polyurethanes, polyamides, particularly aliphatic polyamides such as nylon 6, nylon 6,6, and nylon 6,10, styrene-acrylonitrile polymers (SAN) such as TYRIL, available from Dow Chemical, Midland, Mich., and polycarbonate/polyester blend resins such as, for example, polyester/polycarbonate alloys available from Bayer Plastics under the trade designation Makroblend, those available from GE Plastics under the trade designation Xylex, and those available from Eastman Chemical under the trade designation SA 100 and SA 115, polyesters such as, for example, aliphatic copolyesters including CoPET and CoPEN, polyvinyl chloride (PVC), and polychloroprene.

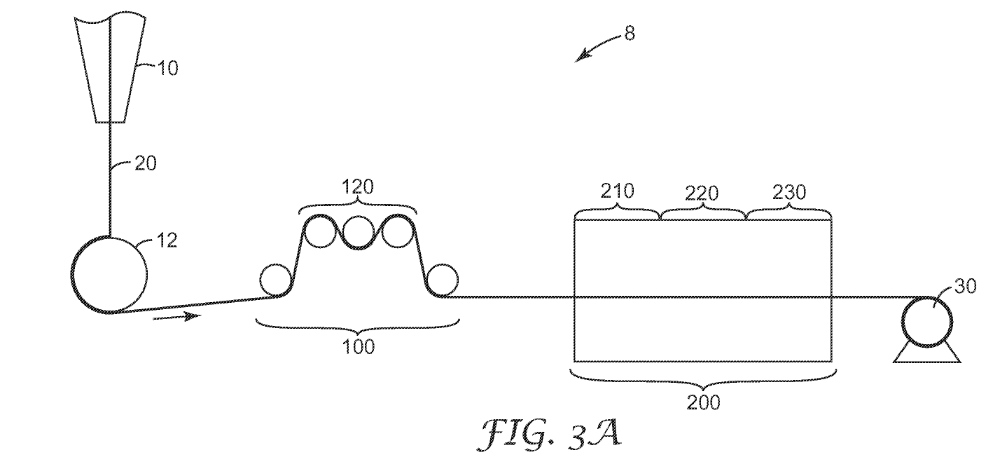

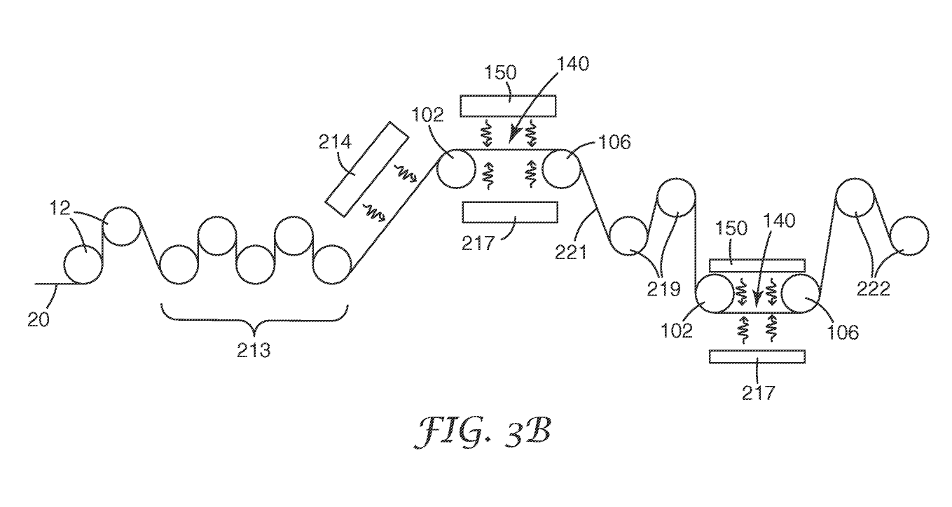

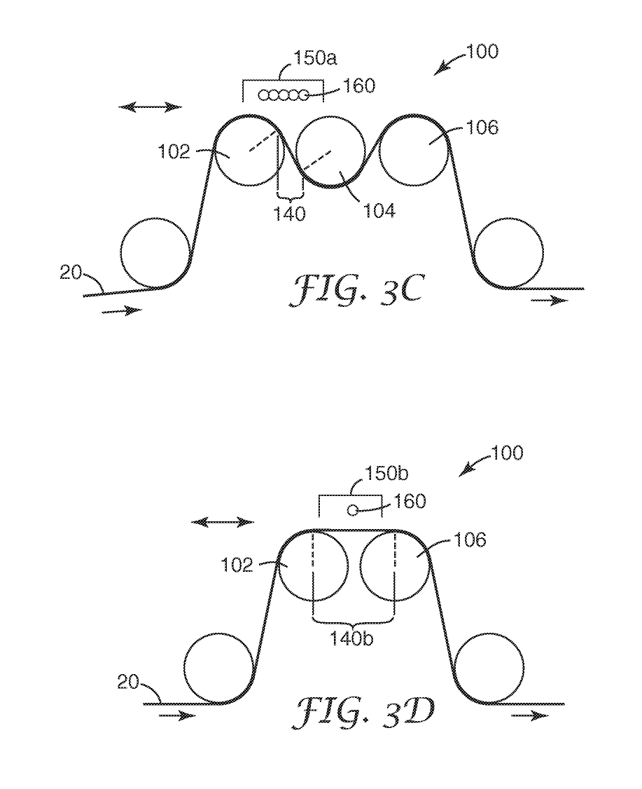

FIG. 3A is a schematic diagram of a film line 8 using a length orienter (LO) for drawing and orienting polymeric film. To impart particular optical and/or physical characteristics to the finished film, polymer 20 can be extruded through a film die 10, the orifice of which can be controlled by a series of die bolts. In one embodiment, a first polymer material and a second polymer material, as described above, are heated above their melting and/or glass transition temperatures and fed into a film die 10. A feedblock (not shown) feeds a film extrusion die 10. Feedblocks useful in the manufacture of the present invention are described in, for example, U.S. Pat. No. 3,773,882 (Schrenk) and U.S. Pat. No. 3,884,606 (Schrenk), the contents of which are incorporated by reference herein to the extent it is not inconsistent with the present disclosure. An extrudate film 20 leaving the die is typically in a melt form.

In some embodiments, a layer multiplier (not shown) splits the multilayer flow stream, and then redirects and “stacks” one stream atop another to multiply the number of layers extruded. An asymmetric multiplier, when used with extrusion equipment that introduces layer thickness deviations throughout the stack, may broaden the distribution of layer thicknesses so as to enable a resulting multilayer film to have polymeric optical layer pairs corresponding to a desired portion of the visible spectrum of light, and provide a desired layer thickness gradient, if desired. In some embodiments, skin layers are introduced into the multilayer optical film by feeding skin layer resin to a skin layer feedblock.

Extruded films can subsequently be oriented, for example by stretching, at ratios determined by the desired properties. Longitudinal stretching can be done by pull rolls in a longitudinal stretch zone 120 of a length orienter (LO) 100, as shown in FIG. 3A. The length orienter typically has one or more longitudinal stretch zones. Transverse stretching can be done in a tenter oven 200 shown in FIG. 3A. The tenter oven 200 usually contains at least a preheat zone 210 and a transverse stretch zone 220. Often the tenter oven 200 also contains a heat set zone 230, as shown in FIG. 3A. Systems can be designed to contain one or more of any or all of these zones. Heat setting is described in commonly owned copending U.S. patent application Ser. No. 11/397,992, filed on Apr. 5, 2006, entitled “Heat Setting Optical Films,” herein incorporated by reference.

After processing, film 20 can be wound on winding roll 30. In one aspect, the present disclosure is directed to a method of making a roll of optical film useful, for example, in an optical display, in which the block axis of the film is generally aligned with the length of the roll. Rolls of this film, typically a reflective optical film such as a reflective polarizing film, may be easily laminated to rolls of other optical films such as absorbing polarizers that have a block state axis along their length.

A film 20 may be laminated with or have otherwise disposed thereon a structured surface film such as those available under the trade designation BEF from 3M Company of St. Paul, Minn. In an exemplary embodiment, the structured surface film includes an arrangement of substantially parallel linear prismatic structures or grooves. In some exemplary embodiments, the optical film may be laminated to a structured surface film including an arrangement of substantially parallel linear prismatic structures or grooves. In an exemplary embodiment, the grooves are aligned along the MD direction, with the block axis of a reflective polarizer film. This is especially useful where the film will be combined with other films in a roll-to-roll process. In other embodiments, the grooves may be aligned along the TD direction or another direction. The structured surface may include any types of structures, a rough surface or a matte surface. Such exemplary embodiments may also be produced by inclusion of additional steps of coating a curable material onto the film 20, imparting surface structures into the layer of curable material and curing the layer of the curable material.

Since exemplary reflective polarizers made according to the processes described herein have a block axis along the downweb (MD) direction, the reflective polarizers may simply be roll-to-roll laminated to any length oriented polarizing film. In other exemplary embodiments, the film may be coextruded with a polymer comprising dichroic dye material or coated with a polyvinyl alcohol-containing (PVA) layer prior to the second draw step.

For uniaxial stretching, stretch ratios of approximately 2:1 to 10:1 may be used. Those skilled in the art will understand that other stretch ratios may be used as appropriate for a given film.

For the purpose of this application, the term “transverse stretch zone” refers to either a purely transverse stretch zone or a simultaneous biaxial stretch zone in a tenter oven. By “tenter”, we mean any device by which film is gripped at its edges while being conveyed in the machine direction. Typically, film is stretched in the tenter. In some embodiments, the stretching direction in a tenter with diverging rails along which the grippers travel will be perpendicular to the machine direction (the stretching direction will be the transverse direction or cross-web direction), but other stretching directions, for example at angles other than the angle perpendicular to film travel, are also contemplated.

Optionally, in addition to stretching the film in a first direction that is other than the machine direction, the tenter may also be capable of stretching the film in a second direction, either the machine direction or a direction that is close to the machine direction. Second direction stretching in the tenter may occur either simultaneously with the first direction stretching, or it may occur separately, or both. Stretching within the tenter may be done in any number of steps, each of which may have a component of stretching in the first direction, in the second direction, or in both. A tenter can also be used to allow a controlled amount of transverse direction relaxation in a film that would shrink if not gripped at its edges. In this case, relaxation may take place in a relaxation zone.

A common industrially useful tenter grips the two edges of the film with two sets of tenter clips. Each set of tenter clips is driven by a chain, and the clips ride on two rails whose positions can be adjusted in such a way that the rails diverge from one another as one travels through the tenter. This divergence results in a cross-direction stretch. Variations on this general scheme are contemplated herein.

Some tenters are capable of stretching film in the machine direction, or a direction close to the machine direction, at the same time they stretch the film in the cross-direction. These are often referred to as simultaneous biaxial stretching tenters. One type uses a pantograph or scissors-like mechanism to drive the clips. This makes it possible for the clips on each rail to diverge from their nearest-neighbor clips on that rail as they proceed along the rail. Just as in a conventional tenter, the clips on each rail diverge from their counterparts on the opposite rail due to the divergence of the two rails from one another.

Another type of simultaneous biaxial stretching tenter substitutes a screw of varying pitch for each chain. In this scheme, each set of clips is driven along its rail by the motion of the screw thread, and the varying pitch provides for divergence of the clips along the rail. In yet another type of simultaneous biaxial stretching tenter, the clips are individually driven electromagnetically by linear motors, thus permitting divergence of the clips along each rail. A simultaneous biaxial stretching tenter can also be used to stretch in the machine direction only. In this case, machine direction stretching takes place in a machine direction stretch zone. In this application, transverse direction stretching, relaxation, and machine direction stretching are examples of deforming, and transverse stretch zone, relaxation zone, or machine direction stretch zone are examples of deformation zones. Other methods for providing deformation in two directions within a tenter may also be possible, and are contemplated by the present application.

The film 20 provided into LO 20 may be a solvent cast or an extrusion cast film. In the embodiment illustrated in FIG. 3A, the film 20 is an extruded film expelled from an extruder die 10 and including at least one, and preferably two polymeric materials. The optical film 20 may vary widely depending on the intended application, and may have a monolithic structure as shown in FIG. 1A, a layered structure as shown in FIG. 1B, or a blend structure as shown in FIG. 2, or a combination thereof.

In an exemplary embodiment, the die 10 lip profile is adjustable with a series of die bolts. For multilayer films, multiple melt streams and multiple extruders are employed. The extrudate is cooled on a rotating casting roll or wheel 12. The film at this point is often referred to as a “cast web”. To orient the film, the film or cast web is stretched in the machine direction, transverse direction, or both depending on desired properties of the finished film. Film processing details are described, for example in U.S. Pat. No. 6,830,713 (Hebrink et al.), hereby incorporated by reference. For simplicity, the present specification shall use the term “film” to denote film at any stage of the process, without regard to distinctions between “extrudate,” “cast web” or “finished film.” However, those skilled in the art will understand that film at different points in the process can be referred to by the alternate terms listed above, as well as by other terms known in the art.

In an exemplary embodiment, the materials selected for use in the optical film 20 are free from any undesirable orientation prior to the draw process. Alternatively, deliberate orientation can be induced during the casting or extrusion step as a process aid to the draw step. For example, the casting or extrusion step may be considered part of the draw step. The materials in the film 20 are selected based on the end use application of the optical film, which in one example will become birefringent and may have reflective properties such as reflective polarizing properties. In one exemplary embodiment described in detail in this application, the optically interfaced materials in the film 20 are selected to provide a film with the properties of a reflective polarizer.

The term orient as used herein refers to a process step in which the film dimensions are changed and molecular orientation is induced in the polymeric materials making up the film. The tendency of a polymeric material to orient under a given set of processing conditions is a result of the visco-elastic behavior of polymers, which is generally the result of the rate of molecular relaxation in the polymeric material.

The relative strength of optical orientation depends on the materials and the relative refractive indices of the film. For example, a strong optical orientation may be in relation to the total intrinsic (normalized) birefringence of the given materials. Alternatively, the draw strength may be in relation to the total amount of achievable normalized index difference between the materials for a given draw process sequence. It should also be appreciated that a specified amount of molecular orientation in one context may be strong optical orientation and in another context may be considered weak or non-optical orientation.

For example, a certain amount of birefringence along a first in-plane axis may be negligible when viewed in the context of a very large birefringence along the second in-plane axis. As the birefringence along the second in-plane axis decreases, the slight orientation along the first in-plane axis becomes more optically dominant. Processes which occur in a short enough time and/or at a low enough temperature to induce some or substantial optical molecular orientation of at least one material included in the optical film of the present disclosure are weak or strong optically orienting draw processes, respectively. Processes that occur over a long enough period and/or at high enough temperatures such that little or no molecular orientation occurs are weak or substantially non-optically orienting processes, respectively.

Uniaxial films 20 can be made using the length orienter 100 using large heated draw gap (L) 140 to film width (W) aspect ratios and low MD draw ratios (λ_{MD}). For a given total L and a given λ_{MD}, the uniaxial character, and thus also the total crossweb (TD) uniformity, can be enhanced by dividing the draw gap 140 into two or more separate segments for a given desired λ_{MD} and/or W. It is believed that shorter draw gaps also enhance the MD stability of downweb caliper fluctuations, thereby resulting in improved final downweb caliper uniformity. Finally, the multi-stage process reduces the tendency of the film 20 to wrinkle during drawing, thus improving heating, draw processing and again the final uniformity.

FIG. 3B illustrates a portion of an embodiment of a film line using multiple draw gaps. The continuous film 20 may be conveyed by rollers 12 into a preheat zone. The conveying rollers 12 may be used to adjust film tension, such as by a dancing mechanism that alters the film path length or through slight differential speed differences (typically less than 1% variation) or both. The preheat zone may comprise a bank of heated rollers 213, a radiant heating source 214, a pre-heat oven, or any combination of these. A typical radiant heating source is an infra-red (IR) bulb or bank of bulbs. The heated rollers may be driven, for example to decrease scuffing or premature stretching of the film. The speeds may increase between rollers, for example to account for thermal expansion. The film 20 may be also stretched slightly, for example to increase film tension or prevent film sagging and loss of flatness. Typically, such pre-stretching and speed adjustments are less than 20%, e.g. less than a 1.2 draw ratio. The amount of pre-heating required depends on the materials and process film speeds. Typically, the film is heated to near the glass transition temperature, such as within 20 degrees C., of at least one material in the film.

Following pre-heating, the film 20 is conveyed to one or more stretching zones, each comprising an initial slow roll 102 and a final fast roll 106. Each is typically driven so that the slow roll 102 resists the pull of the film from the action of the fast roll 106 through the draw gap 140. In an exemplary embodiment, the film 20 is further heated in the draw gap 140.

One typical heating method is radiant heating, such as by IR heating assemblies 150 and/or 217. The film 20 is typically heated above the glass transition temperature of at least every longitudinally (MD) continuous phase or layer in the film 20. Sometimes, a cold stretching is included in which the film 20 is drawn slightly below the glass transition temperature of at least one longitudinally (MD) continuous phase or layer in the film 20. Typically, such cold stretching is within 10 degrees C. of that glass transition temperature. The slow roll 102 may also be a heated roll.

In an exemplary embodiment, after draw across the gap 140, the film 20 is quenched. Typically, the fast roll 106 is a chilled roll set to at least begin the quenching of the film 20. In practice, it may be found that film 20 is not quenched immediately upon contact with fast roll 106 but is instead further drawn for some distance over fast roll 106. In one embodiment, the further drawing occurs over about an inch of film 20 after contact with fast roll 106, thereby increasing the effective aspect ratio L/W. Further cooling may continue, such as through the quenching action of additional rolls 219. These rolls 219 may be set at a reduced speed relative to the fast roll 106, for example to decrease the film tension and allow MD shrinkage or to account for thermal contraction upon cooling. Again, the subsequent conveying rollers may be used to adjust film tension, such as by a dancing mechanism that alters the film path length or through slight differential speed differences (typically less than 1% variation) or both. When the quenching is extended past the fast roll 106 to allow MD shrinkage control, then the speed adjustments can be larger, but typically are less than 20%. In some cases, a final finishing zone 221 can be used. In one embodiment, finishing zone 221 is also heated, such as with radiant heaters, to allow MD shrinkage while separating this process from the tension in a stretching draw gap.

In the illustrated embodiment, another drawing gap 140 is configured in series. Like the first main draw gap 140, each subsequent process draw gap 140 comprises a slow 102 and fast roll 106. The film 20 spans the gap 140 between the rolls 102, 106, is heated and drawn approximately in accord with the ratio of the linear speeds at the roll surfaces. In some configurations, isolating rollers 219 will intervene between the draw gaps 140. One embodiment includes an additional quench or tension control zone 222.

In other configurations, the succeeding draw gap 140 will use the fast roll 106 of the previous draw gap as the slow roll 102 of the succeeding draw gap 140. In the modeling procedures, this roll is referred to as the “center roll.” Again, a final MD shrinking gap may also be included in any of these configurations.

A tendency to wrinkle increases as the span in width, W, or length, L, of the film increases relative to the thickness, T, of the film. Decreasing the values of L/T and/or W/T can reduce the propensity for wrinkling. For example, the intervention of a roller surface contacting and quenching the film can in some cases suppress longitudinal wrinkles that would otherwise appear in the unsupported span. Wrinkling can also occur due to rapid neckdown. Isolating earlier portions of the draw from later portions through the intervention of a quenching roll can also reduce the compression of the neckdown into earlier portions of the draw. Thus, dividing the drawing process into multiple shorter drawing gaps 140 in accordance with the present disclosure can lead to a final film 20 with improved resistance against wrinkling.

After drawing the film 20 along MD, the film 20 may be further treated by heating. The film 20 may be heat set at a temperature above a film temperature used in the stretching process. Heat setting is described in commonly owned copending U.S. patent application Ser. No. 11/397,992, filed on Apr. 5, 2006, entitled “Heat Setting Optical Films,” herein incorporated by reference. Heat setting may be used to alter the properties of the drawn film 20 in a process separated from the main drawing. Additional drawing or strain relaxation can be coupled with the applied heat during heat setting. The film 20 may also be annealed at a temperature below a film temperature used in the stretching process with or without additional strain relaxation, for example to alter the shrinkage characteristics.

Heat setting may be accomplished in diverse manners. The film 20 may be heated to a higher temperature during a final portion of draw. The film 20 may be heated after drawing. The film 20 may be heat set in a separate process step. For example, the film may be stretched in a Length Orienter and then heat-set in a separate oven or heating device. The oven or heating device may be on-line in a continuous process or off-line in a subsequent process. A cooling step, for example to room temperature, may then exist on-line or implicitly in the process of moving to an off-line step.

The oven or heating device may be equipped with an edge gripping mechanism, such as found in a tenter oven device. The edge gripping mechanism may be a clip mechanism attached to a rolling chain along a rail or track as found in many conventional tenters in which the transverse direction draw ratio (TDDR) can be adjusted through the course of the heat setting. Alternatively, the clips may be freely attached to the track by a mounting that is driven independently, such as by a magnetic field as found in simultaneously biaxially orienting LISIM™-driven tenters, available from Bruckner of Sigsdorff, Germany, and described in U.S. Pat. Nos. 4,675,582; 4,825,111; 4,853,602; 5,036,262; 5,051,225; 5,072,493; 5,753,172; 5,939,845 and 6,043,571. In exemplary embodiments of systems of the present disclosure, the TDDR and machine direction draw ratio (MDDR) may be adjusted during the course of heat setting.

The oven or heating device may convey the film 20 using rollers that contact the edges or face of the film 20. For example, the heating device may be configured as a draw gap, such as in a length orienter. The film 20 can be heated using various methods. Non-contact methods of heating such as infra-red heaters may allow higher heat setting temperatures without loss of film integrity.

The TDDR and/or the MDDR can be adjusted in the course of heat setting, as constrained by the flexibility of the particular configuration of the equipment (e.g. conventional tenter, LISM tenter, Length Orienter or other roll driven system) used for the heat setting process step. The MDDR can be maintained, increased or relaxed. When conveyed by rollers, a downstream roll may be driven at a slower speed to decrease the MDDR and relax the film 20 in the MD. Reducing the MDDR during heat setting can reduce shrinkage. In such cases the final MDDR is typically at least 80%, more typically at least 90% of the MDDR before heat setting.

When conveyed by rollers, a downstream roll may be driven at a higher speed to increase the MDDR. A typical range for increased MDDR in such cases may be an increase of 1-20%. The nature of the TDDR constraint during the process can also affect the relationship between the indices. For example, TD tension imposed by a TD constraint may increase the differences between the TD and ND refractive indices. Such constraint may be achieved in one embodiment by simply holding the film in TDDR, such as by parallel gripping elements on the edges of the film while conveying the film through an oven or past a heating device. Lack of TD constraint or the reduction of the TD constraint, such as by a diverging rail and clip system, may actually allow partial TD strain recovery, that is, a reduction in TDDR. In some cases, this may result in a reduction in the relative birefringence. In other cases, the increase in the relative birefringence may be small, e.g. less than 0.01 at 632.8 nm. In some instances, the MDDR and TDDR profiles can be controlled during the progress of heat setting. For example, the MDDR could be increased first to increase draw index and then relaxed slightly to partially relieve residual stresses and thus reduce shrinkage. This may be coordinated with changes in TDDR during the course of heat setting in some process configurations.

FIGS. 3C and 3D are schematic diagrams of two embodiments of a length orienter threading system. In FIG. 3C, pull rolls 102, 104, and 106 are set up in an S-wrap configuration. In FIG. 3D, the pull rolls are set up in a straight or tabletop configuration. In exemplary embodiments, in relative terms, roll 102 rotates slowly, roll 104 rotates at an intermediate rate of speed, and roll 106 rotates quickly. In exemplary embodiments, in relative terms, roll 102 is heated and roll 106 is cool.

The term length orienter encompasses the range of stretching apparatuses in which a continuous film or web of polymer 20 is conveyed and stretched in the span or draw gap 140 between at least one pair of rollers, in which the linear (tangential) velocity of the downstream roll 106 is higher than the linear velocity of the upstream roll 102 of the pair. The ratio of the differential velocities along the film path, fast to slow roll, is approximately equal to the machine-direction draw ratio (MDDR) across the span 140.

Film 20 is conveyed through a series of pre-heated rollers 102, 104, 106 to a draw gap 140, 140b. The film 20 is drawn due to the differences in speed between the initial and final rollers defining the draw gap 140, 104b. Typically, the film 20 is heated with infrared radiation as it spans the gap 140, 140b to soften the film 20 and facilitate the drawing above the glass transition temperature. The embodiments depicted in FIGS. 3A and 3B employ heating assemblies 150a-b for providing a distribution of heat to the longitudinal stretch zone 140 or 140b of the film 20.

In the embodiment shown in FIG. 3C, the heating assembly 150a comprises three transverse infrared heating elements 160. Although this particular embodiment illustrates a set of three heating elements 160, any number and type of heating elements can be used, depending on the design considerations of the system. For example, a system having a single heating element (heating assembly 150b) is shown in FIG. 3D. Each transverse heating element 160 can be a single heater spanning the entire width of the film area to be controlled, or a plurality of smaller heaters, including point sources of heat, arranged to provide the desired amount of heat to the film area to be controlled. Combinations of point sources and extended sources of heat are also contemplated.

The illustrated process can be used for many products, including visible, colored and infra-red mirror film products. Caliper (thickness) and draw ratio variations of optical films can cause undesired color. For example, films designed to reflect a certain band of color in the visible wavelengths can shift color. In another example, films designed to reflect a narrow infra-red band may exhibit visible color due to caliper fluctuation. The width of the reflection band allowed, without such color, decreases as the caliper variations increase. Reduced caliper variation allows for an increased band width with resulting increased reflective power.

The phrase “consisting essentially of a uniaxial stretch” refers to stretching a film uniaxially in a first stretch direction and optionally, in a second stretch direction different than the first stretch direction, such that the stretching in second direction, if any, does not produce appreciably alter the birefringence. Stretching in the second direction can be performed simultaneously as the stretching in the first direction, or subsequent to the stretching in the first direction, as desired. Stretching the film in a second direction such that the stretching in the second direction alters the birefringence is termed a “biaxial” stretch.

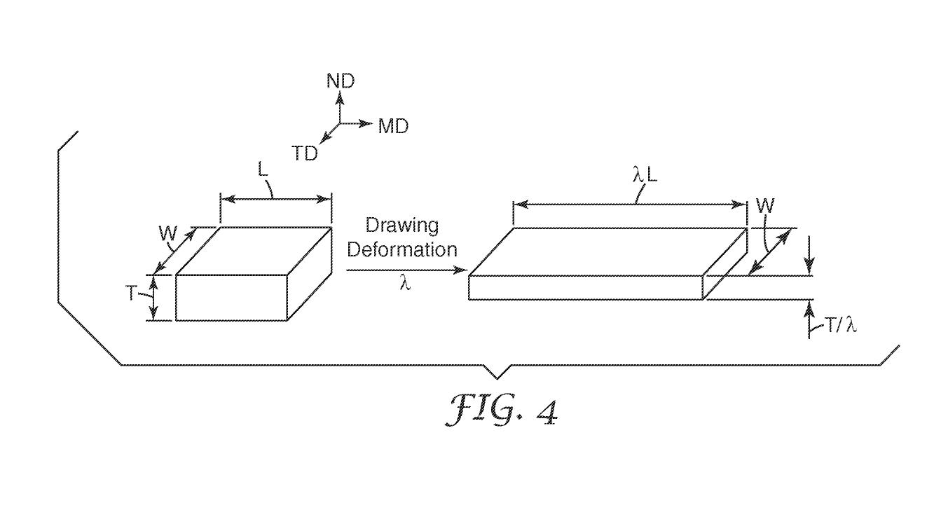

Perfect uniaxial stretching conditions, with an increase in dimension in the transverse direction, result in TDDR, MDDR, and NDDR of λ, (λ)^{-1/2}, and (λ)^{-1/2}, respectively, as illustrated in FIG. 4 (assuming constant density of the material). In other words, assuming uniform density during the stretch, a uniaxially oriented film is one in which MDDR=(TDDR)^{-1/2} throughout the stretch. A useful measure of the extent of uniaxial character, U, can be defined as:

$$U = \frac{\frac{1}{MDDR} - 1}{{TDDR}^{1 / 2} - 1}$$

For a perfect uniaxial stretch, U is one throughout the stretch. When U is less than one, the stretching condition is considered “subuniaxial”. If the film is biaxially stretched so that MDDR is greater than unity, U becomes negative. When U is greater than one, the stretching condition is considered “super-uniaxial”. States of U greater than unity represent various levels of over-relaxing. These over-relaxed states produce an MD compression from the boundary edge. If the level of MD compression is sufficient for the geometry and material stiffness, the film will buckle or wrinkle. For high optical performance, a U of 0.7 or greater is generally desired. For other optical applications, a U value of 0.2 or more is generally desired.

A change in density of the material can occur for a variety of reasons including, for example, due to a phase change, such as crystallization or partial crystallization, caused by stretching or other processing conditions. Where the density of the film changes by a factor of ρ_{f}, where ρ_{f}=ρ₀/ρ with ρ being the density at the present point in the stretching process and ρ₀ being the initial density at the start of the stretch, then U can be corrected for changes in density to give U_{f} according to the following formula:

$${U}_{f} = \frac{\frac{1}{MDDR} - 1}{{( \frac{TDDR}{{ρ}_{f}} )}^{1 / 2} - 1}$$

A fundamental study of the base caliper response of a visco-elastic film drawn in a length orienter reveals two preferred regimes for process operation. The first preferred draw regime is one in which the process yields a nearly uniaxially oriented film, hereafter referred to as the “uniaxial” regime. The second preferred draw regime is one in which the process yields a nearly “pure shear extension” in the major, center portion of the drawn film, and yields a relatively more uniaxial condition in a minor edge portion of the drawn film, hereafter referred to as the “planar extension” regime.

The two preferred regimes represent certain extremes in the process conditions. The uniaxial regime is achieved using relatively narrow films in relatively long heated draw gaps at relatively low draw ratios. Conversely, the planar extension regime is achieved using relatively wide films in relatively short heated draw gaps at relatively high draw ratios. The absolute sizes or levels of film width (W), process heated draw gap (L) and draw ratio (DR) are relative to each other. For example, the aspect ratio of the heated draw gap to the film width, i.e. L/W, is a key factor. The critical aspect ratio to achieve either regime is in turn a function of the level of MD draw; e.g. a given aspect ratio representative of the planar extension regime at one draw ratio may yield the uniaxial regime at a much lower draw ratio as further detailed in the following.

Reference to a “heated draw gap” or “effective draw gap” refers to the heated length of a draw gap 140. Thus, an effective draw gap may be the length between the tangents of adjacent rollers in one embodiment. In another embodiment, an effective draw gap may be shorter than the length between tangents if the heaters are set to heat a shorter portion of the film 20 in the draw gap 140. In yet another embodiment, the effective draw gap may be longer than the length between tangents if there is slippage on the rolls and residual heating outside of draw gap 140.

A variety of quantities are useful in describing the uniformity of the draw, including the draw ratios or dimensional length changes in the three process directions. The three process directions are along the machine direction of film travel and length orientation (MD), the in-plane crossweb direction transverse to this draw direction (TD), and the out-of-plane thickness direction normal to each of these (ND). It should be understood that while the present disclosure refers to three “orthogonal directions,” the corresponding directions may not be exactly orthogonal due to non-uniformities in the film. The orthogonal directions also coincide with the average directions of draw within the film after it exits the LO process. The draw ratios, λ_{MD}, λ_{TD} and λ_{ND} are the ratios of final to initial lengths of the respective sides of a volume element of the film measured at the same temperature and pressure.

For an incompressible film, the product of the three draw ratios is unity. For a compressible or densifying film, e.g. via crystallization, the product of the three draw ratios is equal to the ratio of the final to the initial volume at the same temperature and pressure. The draw ratios in the film may vary as functions of both the MD and TD positions. During the drawing, severe changes occur to the film in MD as the film travels and is drawn in that direction. Non-uniformity may persist along MD in the final film. However, the thrust of this disclosure is improved uniformity as measured across TD. Thus the improved uniformity of the draw ratios and resulting physical properties of the film as a function of TD position within the final film are described.

FIG. 4 illustrates a one-directional stretching process that stretches film in the direction of film travel, where the width is constrained. The film may be continuously fed or introduced as a non-continuous portion of film. The film travel direction is referred to as the machine direction (MD). An initial, unoriented portion in the film may be stretched into a final, oriented portion. As shown in FIG. 4, the unoriented portion of the film may have dimensions T (thickness), W (width) and L (length). After the film is stretched by a factor of λ, the dimensions of that portion of film have changed to those shown in FIG. 4.

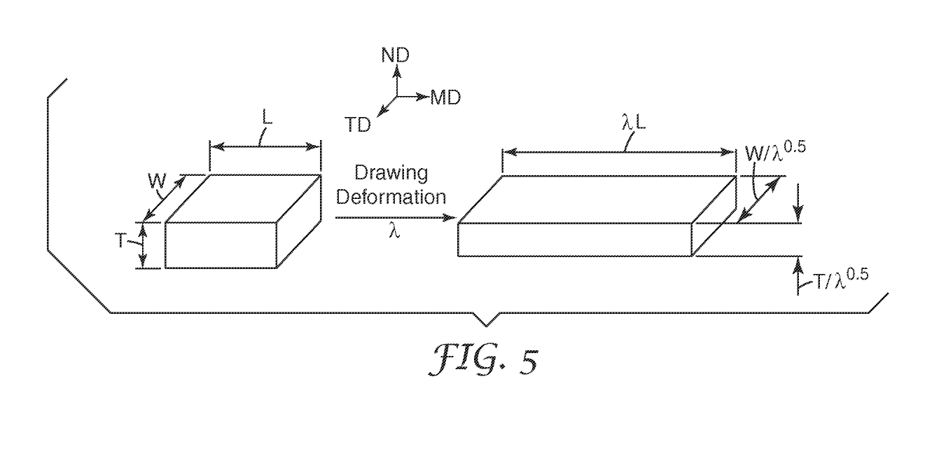

FIG. 5 is a schematic illustration of the deformation of a unit of film in a uniaxial stretching process. A substantially uniaxial stretching process stretches the film from an initial configuration to a final configuration. The machine direction (MD) is the general direction along which the film travels through a stretching device, for example, a LO apparatus. The transverse direction (TD) is the second axis within the plane of the film and is orthogonal to the machine direction. The normal direction (ND) is orthogonal to both MD and TD and corresponds generally to the thickness dimension of the polymer film.

In some embodiments of the present disclosure, an optical film may be uniaxially-oriented, for example, by stretching (i.e., drawing) in a substantially single direction. A second orthogonal direction may be allowed to neck into some value less than its original length, as desired. In some exemplary embodiments, the first optical layers may be oriented or stretched (i.e., drawn) in a manner that departs from perfectly uniaxial draw but still results in a reflective polarizer that has a desired optical power. Such nearly uniaxial stretch may be referred as “substantially uniaxial” stretch. The term “uniaxial” or “substantially uniaxial” stretch refers to a direction of stretching that substantially corresponds to either the x or y axis (an in-plane axis or direction) of the film. For the purposes of the present disclosure, the term “uniaxial stretch” shall be used to refer to both perfectly “uniaxial” and “substantially uniaxial” stretches. However, other designations of stretch directions may be chosen. In many embodiments, the reflective polarizer is drawn uniaxially or substantially uniaxially in the transverse direction (TD), while allowed to relax in the machine direction (MD) as well as the normal direction (ND). Suitable apparatuses that can be used to draw such exemplary embodiments of the present disclosure and definitions of uniaxial or substantially uniaxial stretching (drawing) that can be used to draw such exemplary embodiments of the present disclosure are described in U.S. Pat. No. 6,916,440, and U.S. Patent Application Publications No. US2002/0190406, US2002/0180107, US2004/0099992 and US2004/0099993, the disclosures of which are hereby incorporated by reference herein.

The phrase “consisting essentially of a uniaxial stretch” refers to stretching a film uniaxially in a first stretch direction and optionally, in a second stretch direction different than the first stretch direction, such that the stretching in second direction, if any, does not produce appreciably alter the birefringence. Stretching in the second direction can be performed simultaneously as the stretching in the first direction, or subsequent to the stretching in the first direction, as desired. Stretching the film in a second direction such that the stretching in the second direction alters the birefringence is termed a “biaxial” stretch.

Films falling within the uniaxial regime may be produced by methods including batch processes and the substantially uniaxial stretching processes described in commonly owned U.S. Pat. Nos. 6,939,499; 6,916,440; 6,949,212; and 6,936,209; and commonly owned U.S. Patent Application Ser. No. 60/713,620 (Attorney Reference No. 61165US002), filed Aug. 31, 2005; all incorporated herein by reference.

The present disclosure describes a process using multiple drawing stages to achieve a film of high ultimate draw ratio possessing uniaxial character. Uniaxial character is particularly desired to make so-called matched z-index polarizers (MZIPs), in which the crossweb (TD) and thickness (ND) direction refractive indices are similar within each material layer and among the material layers. This is particularly difficult to achieve in polyester-based films by simple uniaxial drawing due to the tendency of the aromatic rings to align in the plane of the film under planar extension. Prevention of this aromatic planarization and maintenance of cylindrical symmetry in the refractive index tensor can be achieved by ensuring a uniaxial draw.

Using the machine direction draw ratio (MDDR) as set by the process inlet and outlet roll speeds; the transverse direction draw ratio (TDDR) as estimated by the cast to drawn mass balance mapping; and the normal direction draw ratio (NDDR) as calculated by the ratio of the final to initial cast thickness (as mapped across TD); the extent of uniaxial character was estimated using the formula

U=(1/TDDR−1)/(1/MDDR^{0.5}−1)

which is analogous to the formula provided for a transverse draw in U.S. Pat. No. 6,939,499, hereby incorporated by reference. The small variation in density with drawing and crystallization was estimated to be negligible (e.g. less than 2%) and thus ignored.

The two drawing regimes illustrated in FIGS. 4 and 5 are further described in co-pending commonly owned Patent Application Docket No. 61869US002, entitled “Processes for improved uniformity using a length orienter,” incorporated herein by reference.

The following examples include exemplary materials and processing conditions in accordance with different embodiments of the disclosure. The examples are not intended to limit the disclosure but rather are provided to facilitate an understanding of the invention as well as to provide examples of materials particularly suited for use in accordance with the various above-described embodiments.

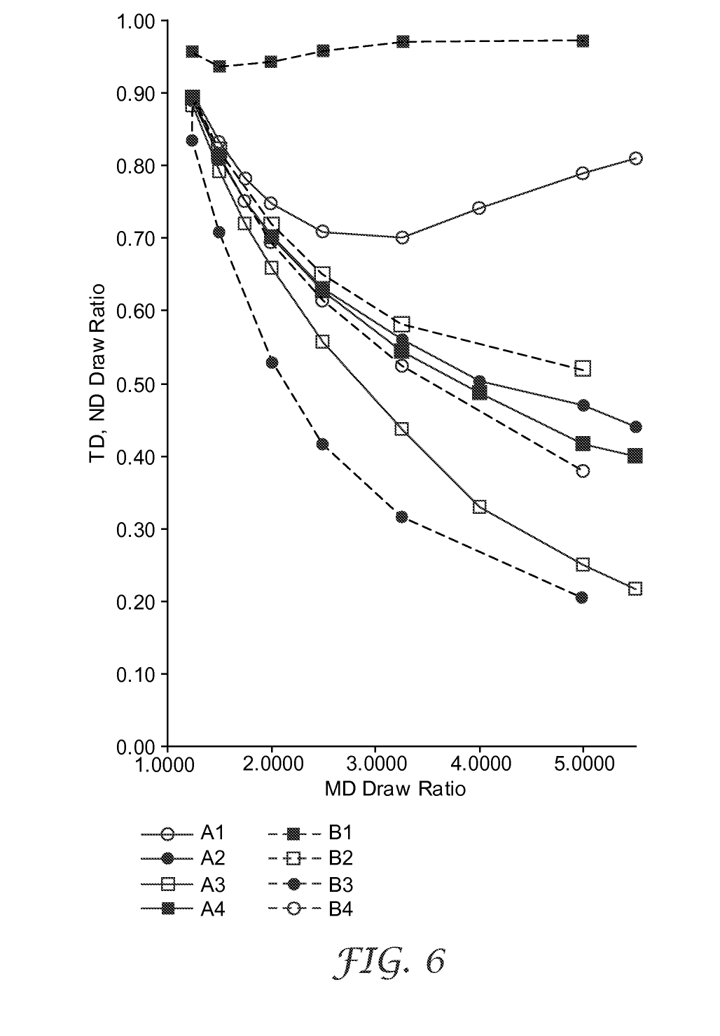

FIG. 6 is a graph illustrating uniaxial character vs. draw ratio at low and moderate L/W aspect ratios. Using model data, FIG. 6 demonstrates how the crossweb (TD) and thickness (ND) draw ratios diverge at increasing MD draw ratio for portions of polyethylene film at the center and edge for low (Case B, L/W=0.5) and moderate (Case A, L/W=2.1) L/W aspect ratios. These data were obtained by process modeling, as opposed to experimental results. Details of the modeling procedures are further discussed at the end of the present disclosure.

Cases A1-A4 correspond to a 2.1 L/W aspect ratio. Case A1 corresponds to the TD draw ratio at the center of the film. Case A2 corresponds to the TD draw ratio at the edge of the film. Case A3 corresponds to the ND draw ratio at the center of the film. Case A4 corresponds to the ND draw ratio at the edge of the film.

Cases B1-B4 correspond to a 0.5 L/W aspect ratio. Case B1 corresponds to the TD draw ratio at the center of the film. Case B2 corresponds to the TD draw ratio at the edge of the film. Case B3 corresponds to the ND draw ratio at the center of the film. Case B4 corresponds to the ND draw ratio at the edge of the film.

Uniaxial character is maintained when the TD and ND draw ratios are similar at both center and edge. This is achieved in Case A for draw ratios of about 2 and below. One concept of the present disclosure is to reduce the MD draw ratio over a given draw gap below the threshold of substantial TD/ND draw ratio divergence.

Higher total draw ratios are achieved using additional draw gaps in subsequent drawing stages. If the critical MD draw ratio for a desired level of TD/ND similarity at a given initial aspect ratio is λ* and the final desired draw ratio is λ_{final}, then an estimate of the number of desired draw gaps is n, where n is found by the equation:

λ_{final}=(λ*)ⁿ (1)

Assuming n fast rollers ending n draw gaps, the various fast rollers, j, where j varies from 1 to n, may be set to relative speeds of (λ*)^{j} times the slow roll at the first gap. The various draw ratios would also increment in like fashion. In particular, the cumulative draw ratio, Cⱼ, at the end of each jth gap is thus also (λ*)^{j}.

Using equation (1), a useful configuration in some instances for a multiple draw gap with n draw gaps, a total of L effective draw gap summed along all the gaps, and a predetermined final desired draw ratio, sets each individual effective draw gap length, Lⱼ to the value of L/n, while setting the cumulative draw ratio of each gap Cⱼ to the quantity (λ*)^{j}. In a variation of this configuration, the draw gaps are set to values of δⱼL/n where each δⱼ is a value between 0.9 and 1.1. Again the sum of the Lj is equal to L. In some cases, the draw ratios can also vary by a small amount from their standard ratios of this method, e.g. by a factor between 0.9 and 1.1. In some of these cases, it is preferred to maintain a monotonic increase in the cumulative draw ratio.

A related useful configuration in some instances for a multiple draw gap with n draw gaps, a total of length of L for the effective draw gap summed along all the gaps and a predetermined final desired draw ratio, sets each individual effective draw gap length, Lⱼ, so that the effective aspect ratio Lj/Wj is relatively constant among the gaps, while setting the cumulative draw ratio of each gap Cⱼ to the quantity (λ*)^{j}. In particular, the width Wj of the film entering each draw gap j is W/(λ*)^{(j-1)} in the limit of perfect truly uniaxial drawing. In this method, the various Lⱼ are set according to equation (2):

Lⱼ=L[(λ*)^{(-1/2)}−1](λ*)^{[-(j-1)/2]}/[(λ*)^{(-n/2)}−1] (2)

For example, consider a draw ratio of 5.06 over two draw gaps (n=2), so that λ* is 2.25. Then it follows that L₁ is 0.40 L and L₂ is 0.60 L. In another example, consider a three gap system (n=3) with a final draw ratio of 5.62, so that λ* is 1.78. Then it follows that L₁ is 0.433 L, L₂ is 0.324 L and L₃ is 0.243 L. In a variation of this configuration, the draw gaps are set to values of γⱼLⱼ where each γⱼ is a value between 0.9 and 1.1. Again, the sum of the Lⱼ is equal to L. In some cases, the draw ratios can also vary by a small amount from their standard ratios of this method, e.g. by a factor between 0.9 and 1.1. In some of these cases, it is preferred to maintain a monotonic increase in the cumulative draw ratio.

The two useful configurations above may be combined to describe a third useful configuration in which each Lj lies between δⱼL/n and γⱼLⱼ (as defined by equation 2) while setting the cumulative draw ratio of each gap Cⱼ to the quantity (λ*)^{j}. In some cases, the draw ratios can also vary by a small amount from their standard ratios of this method, e.g. by a factor between 0.9 and 1.1. In some of these cases, it is preferred to maintain a monotonic increase in the cumulative draw ratio.

Due to the non-linearities of the drawing process and the reduction of the aspect ratio after each stage, assuming constant draw gap lengths across stages, it may be desired to vary the distribution of draw ratios among the stages from the implied product distribution of equation 1. For example, the peak rate of change of the MD or the TD Hencky strain for each draw gap can be minimized among the draw gaps for a given number of draw gaps n.

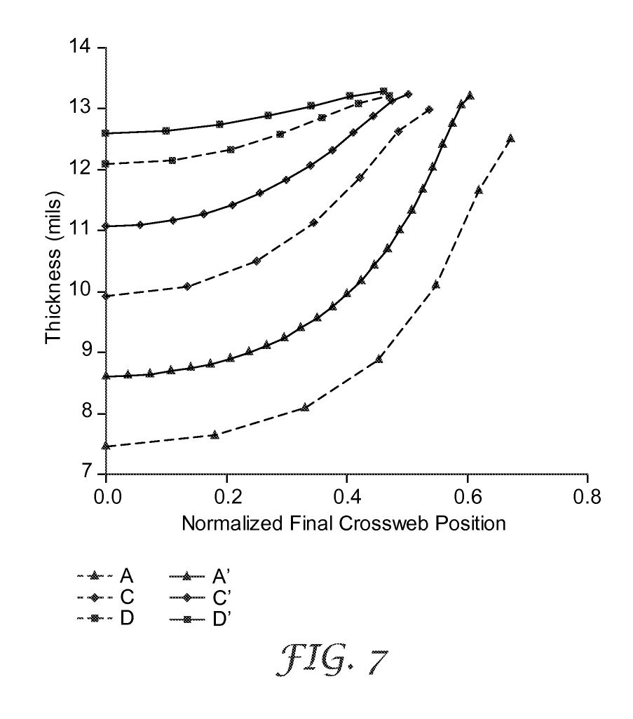

FIG. 7 compares the use of two draw gaps of total length equal to a single draw gap in model Cases A, C and D with increasing L/W aspect ratios of 2.1, 4.2 and 8.4, respectively. Each model film initially had a uniform 0.030″ (0.76 mm) thickness; each model film was drawn to approximately five times in MD.

FIG. 7 presents the crossweb caliper profile of the final films. Referring again to FIG. 5, as the crossweb caliper of the drawn film, from an initially uniform cast web, also becomes uniform with a thickness reduced by a factor of (λ_{MD})^{-1/2} from the initial caliper, the final film becomes uniaxial. In FIG. 7, the single stage Cases A, C and D are compared to sister cases A′, C′, and D′ in which the total length of the draw gap is maintained but the draw is divided into two stages, each with an MD draw ratio of the square root of 5.0. In each case, the result of the two-stage process is substantially more uniform in thickness than the corresponding one-stage process. A careful examination of the model reveals the slippage of the film over the intermediate roller resulting in a longer effective draw gap, and larger L/W of approximately 3, 6 and 12, for case A′, C′ and D′ respectively. This may account for the intermediate behavior of Case A′ to A and C, and C′ to C and D as well as the most uniform behavior of Case D′. When an intermediate roller is not an effective quenching roll, then the crossweb profile behavior may be similar to a single gap result where the effective draw gap is the sum of the path length between quenching rollers.

From the results of FIG. 7, it follows that a multiple draw gap system can be treated as a single draw gap system under certain conditions. When a single draw gap process is optimized for a certain level of performance, for example the L/W ratio is determined for a given draw ratio to achieve a certain level of truly uniaxial character or caliper uniformity, then a variety of multiple draw gap processes can be mapped to it. A multiple draw gap process allows a more compact process and may provide web stability and the suppression of wrinkles and other out-of-plane distortions during drawing that can diminish the performance of an optical film. Moreover, the mapping allows for a sensible mapping of a scaled process. For example, it may be desired to replicate the process on a much wider film, requiring a much longer draw gap. The method provides a way to design such a process using multiple draw gaps including the approximate settings for the various intermediate rolls. In the following description, the single gap baseline case is the particular case chosen with a given draw ratio, effective draw length and initial width, that achieves a desired level of a particular property such as caliper uniformity or extent of uniaxial character U.

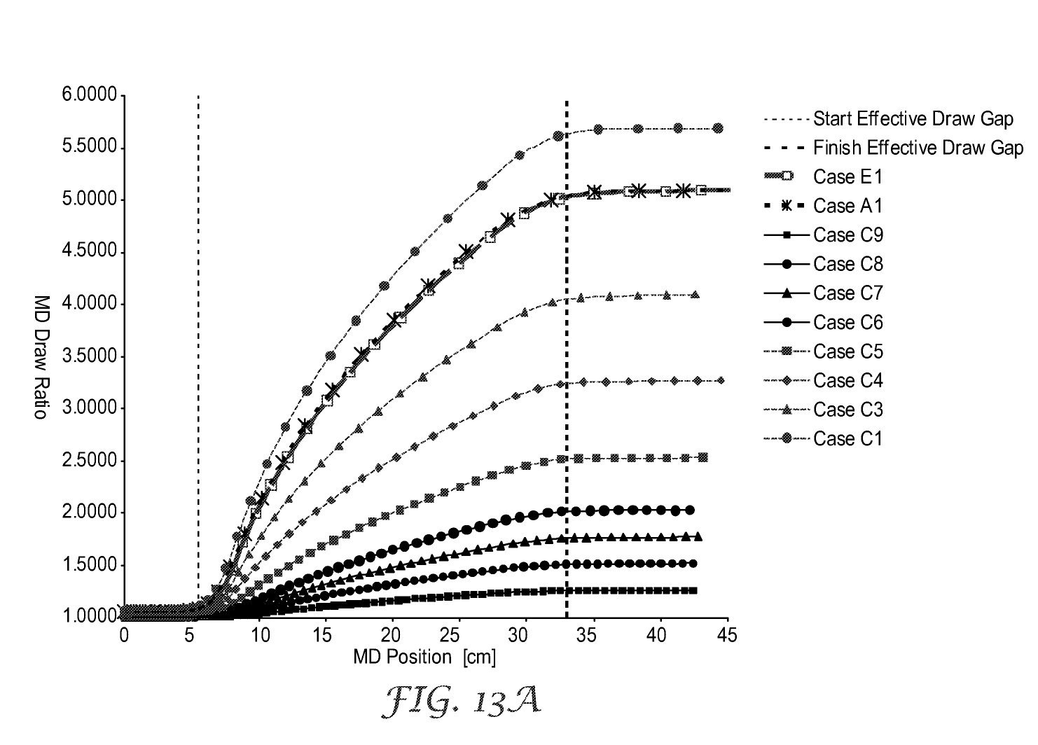

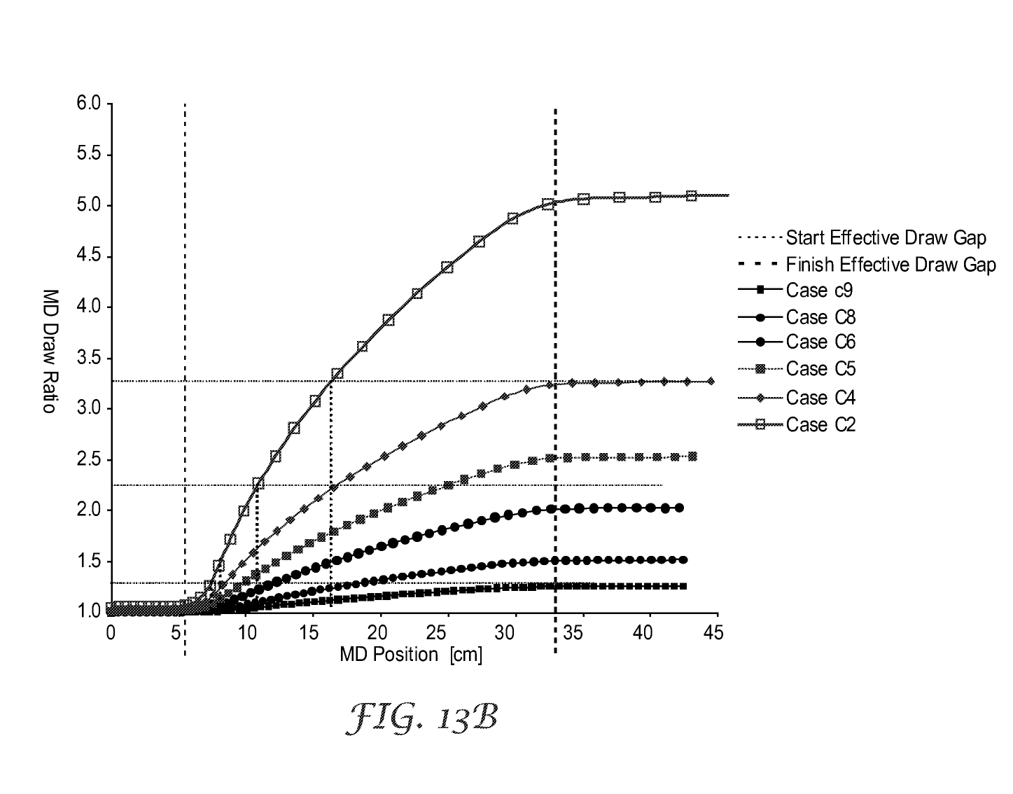

FIG. 13A shows the approximate progress of the draw ratio with MD position in accord with a single gap model simulation similar to that presented in FIG. 7. Each of the cases C1 through C9 have an L/W ratio of 2.1. Case C1 corresponds to an MD draw ratio of 5.50; case C2 corresponds to an MD draw ratio of 5.00; case C3 corresponds to an MD draw ratio of 4.00; case C4 corresponds to an MD draw ratio of 3.25; case C5 corresponds to an MD draw ratio of 2.50; case C6 corresponds to an MD draw ratio of 2.00; case C7 corresponds to an MD draw ratio of 1.75; case C8 corresponds to an MD draw ratio of 1.50; and case C9 corresponds to an MD draw ratio of 1.25. Cases A1 and E1 are similar to Case C1 but with L/W ratios of 0.5 and 8.4 respectively. In practice, the Hencky strain progress can be alternatively measured for materials that can be marked, for example gridded with ink. Lines can be drawn across the TD prior to stretching, such as with an inked, lined roller. The separation of these marks in the drawing process can be recorded, such as by a video camera system. Thus, for any particular material system and process configuration, an equivalent map to FIG. 13A can be derived.

The single draw gap baseline process in a first approximation can be mapped to a multiple draw gap process by dividing the draw gap into parts. When the width of the film is the same for the single and multiple draw gap process, each gap has an effective draw length Lⱼ so that the sum of Lⱼ is equal to the total single effective draw gap length L. When the width is increased, the effective lengths are proportionately increased to maintain the aspect ratio. The actual lengths of each gap must be the sum of the effective length and the extra or non-effective length required for heating, etc. In some cases, this extra length may be similar to the non-effective length in the single gap case. The actual amount depends on factors such as the nature and configuration of the film heating system. The various fast rolls are then set to achieve the draw ratios anticipated by the single gap MD draw ratio profile.

The method is illustrated in FIG. 13B. In this example, the draw gap is divided into five effective draw gaps of lengths at MD positions 7.1, 8.0, 10.9 and 16.7 and 32.5 cm by a series of vertical lines corresponding to MD draw ratios of 1.25, 1.5, 2.25, 3.25 and 5. The effective draw gap starts around 5.5 cm and ends around 32.5 cm. The total single gap length is thus about 27 cm. The effective draw gaps are then 1.6, 0.9, 2.9, 5.8 and 15.8 for the five draw gaps. The cumulative draw ratios at each gap should be the corresponding draw ratios of 1.25, 1.5, 2.25, 3.25 and 5, respectively. These ratios are thus the speed of each fast roll divided by the speed of the initial slow roll of the first gap. Additional lengths in gap would be needed to accommodate the heating of the film in each gap. If the desired film width were double the original in the single gap, then the effective lengths would be doubled and the additional lengths in the gaps for heating added to these doubled values. The draw gap can be divided into other lengths or number and the draw ratios set in like manner.

When an intermediate roller effectively isolates the stretching between draw gaps, then each draw gap can be considered separately. This can be achieved by adequate quenching of the intermediate fast roll, or by sufficient wrap angles, or by the use of several intervening rolls between draw gaps, or by a combination of these means, for example. The stress between draw gaps are then isolated through the action of the intermediate isolating roll or rolls and slippage is prevented.

It is believed that strain hardening with increasing draw ratio tends to compress the neckdown earlier into the draw. This tends to diminish the approach to the truly uniaixial regime for a given single gap length. For example, the distance on curve C2 of FIG. 13B to achieve an MD draw ratio of 1.5 is about 2.5 cm, but to achieve an similar relative increase from 3.25 to 5.0 uses more than half the draw gap, about 15.8 cm. The shearing strain inducing compressive wrinkling is thus expected to be less severe in the second portion of the draw gap. Moreover, the relative amount of TD neckdown in the second portion of the single draw gap is much less. Using the single draw gap profile and the method for mapping it onto a multiple draw gap process as a baseline, a further improved method for setting the draw ratios of the intermediate rollers can now be provided.

In general, MD draw ratio settings that are lower in the first or first group of draw gaps relative to the single gap baseline case may tend to reduce wrinkling and also improve the extent of uniaxial character of the film. MD draw ratio settings that are higher in the first or first group of draw gaps relative to the single gap baseline case may tend to improve the planar extension character. The apportionment of effective draw gap length can also be adjusted starting from a fixed draw ratio sequence among the gaps to achieve the same effect.

In order to more deeply penetrate the uniaxial regime, e.g. increase the extent of uniaxial character U, the sequence of draw ratios in the first portion of the draw comprising the first or first group of draw gaps should not be so extreme that a subsequent portion of the draw requires an excessive neckdown and draw ratio increase over insufficient length for a given width. To discern a first limitation to the amount of redistribution of the gap length, consider again λ*, by which a single effective draw gap is partitioned into n gaps of equal lengths and equal increments of Hencky strain. A rough rule of thumb limits the division of the gaps so that no gap has proportionately less effective draw gap per unit Hencky strain than the first draw gap has under the baseline condition of a single gap. This can be applied either to the MD draw ratio settings or to the sizes of the various gaps. For example, in the case depicted in FIG. 13B, the first effective draw gap is 1.6 cm. The MD draw ratio at this draw gap length for the single gap baseline is 1.25 and the Hencky strain increase is therefore 0.22. The increase in Hencky strain units per cm is 0.14. If the second to last fast roll is set to accomplish an MD draw ratio of 3.25, then the Hencky strain increment over the final draw gap is 0.43 and the final effective draw gap should be at least 3.1 cm in this example. In general, other factors may come into play, such as excessive stress development due to increased draw rates over the shorter gap, thus increasing the needed length from the lower bound estimate provided by this method. Again, the actual draw gaps should include the additional length required for heating of the film.

A second limitation to the redistribution of the gap lengths follows again from FIG. 13A and FIG. 13B. A first draw gap or group of draw gaps should not be made so long and set to such a low final draw ratio by the last fast roll of the group that the remaining draw gaps exceed the baseline behavior over the subsequent draw. Consider n draw gaps with effective draw gaps Lⱼ and fast-to-slow roll speed ratios of λⱼ, where j varies from 1 to n, so that the accumulated draw ratio up to the kth fast roll is the product of the λⱼ from j equal 1 to k. Then the factor increase in the draw ratio over a final portion of the drawing from the kth fast roll to the final fast roll is the ratio of the final draw ratio to the accumulated draw ratio up to the kth fast roll.

Using the MD draw ratio profile, e.g. from FIG. 13A or suitable experimental measurement, the effective draw gap length should not be less than the effective draw gap length of the baseline single gap case for an initial draw ratio equal to this factor increase in the draw ratio over the final portion. This constraint should be applied for every value of k between 1 and n−1. For example, the single draw gap process of case C2 could be mapped onto a multiple draw gap process comprising n=2 draw gaps with a first draw ratio of 1.5 and a second draw gap ratio of 5. The second fast roll requires a speed increase over the first fast roll of about 3.3. Assuming the first fast roll is the slow roll for the second gap, then λ₂ equals 3.3; that is, the second gap causes an additional draw ratio increase of a factor of 3.3. Because there are only two draw gaps, the factor increase in the draw ratio over a final portion of the drawing is simply this value of 3.3, that is, λ₂. Using this factor increase as the draw ratio in FIG. 13B, the MD position is approximately 16.7 and the effective draw gap needed to achieve this draw ratio is about 11.2 cm. At a constant effective draw gap of 27 cm for this baseline case, the first draw gap should not exceed 15.8 cm at the chosen first draw ratio of 1.5 for this example. Some relaxation of this constraint may be considered in light of the decreased draw width at the start of the second draw gap; however, this may be counter-balanced in practice by the strain hardening at high draw ratio which may sharpen the ascent of the MD profile in a subsequent gap.

In order to improve the planar extensional character, the MD draw ratio at the end of the first or first group of draw gaps should be high enough, e.g. a high enough draw ratio (e.g. 4 or more) or high enough in orientational effect on the film (e.g. above a critical index in a continuous layer or phase) to prevent breadth reduction in the subsequent portion of the draw, as described later.

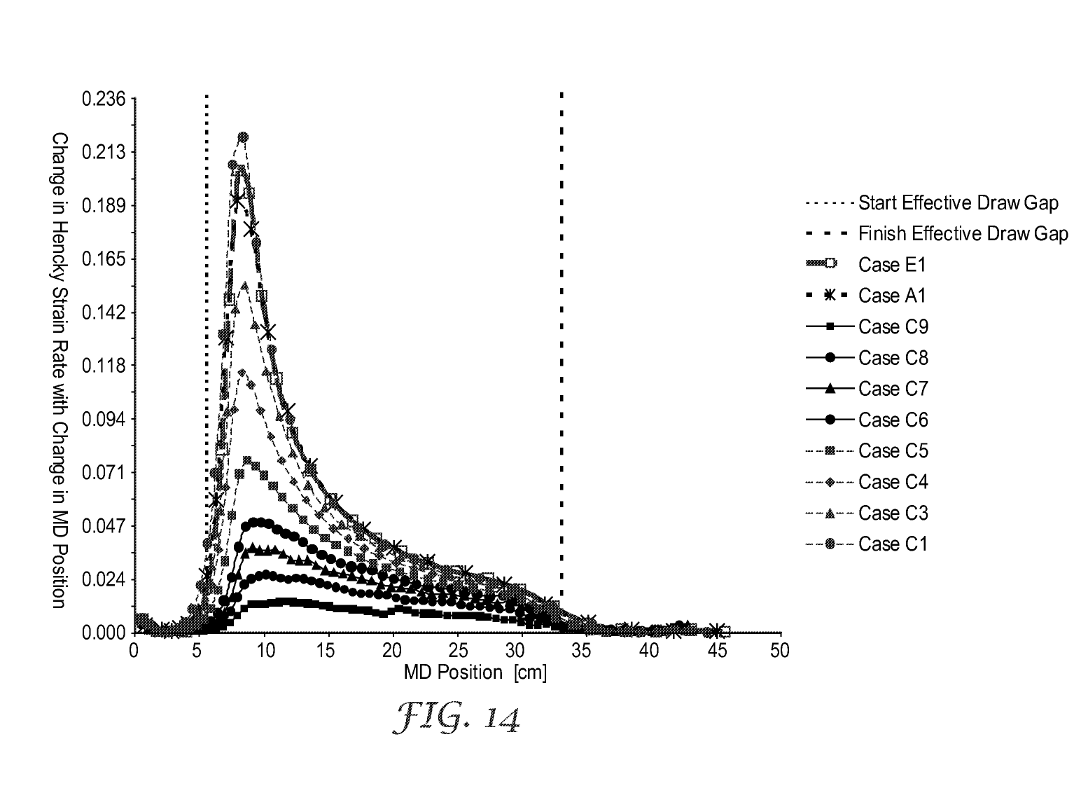

FIG. 14 shows the rate of change of Hencky strain with MD progress in accord with the same model as FIGS. 13A and 13B. Surprisingly, an interesting pattern emerges for the peak rate of change, or alternatively, for the average rate of change over a small interval about this peak, in which the (average) peak value drops by about a factor of two as one progresses down from draw ratios of 5 to 3.25 to 2.25. The latter value can be discerned implicitly by interpolation between the values at 2.5 and 2.0. The (average) peak value drops again by a factor of two (slightly more) down to a final draw of 1.5 and then again by a factor of 2 down to 1.25. This region of high change in Hencky strain along MD in the gap is where a significant portion of the MD draw and TD neckdown occur. From a geometrical standpoint, if the length dimension is compressed by a factor of two, then it appears that to maintain a rough equivalency in the neckdown behavior, the width dimension should likewise be reduced by a factor of two. As the rate of (average) peak Hencky strain doubles with increasing draw ratio, then halving the width (e.g. halving the L/W ratio at constant effective draw gap length) roughly compensates and approximately similar crossweb variations across the final width of draw film can be found.

In many cases, a rule of thumb for finding equivalentt conditions for a single gap process running the same material at the same line speed (which can alter the heating and thus the effective draw gap) can now be presented. Defining H as the Hencky strain, then dH/dx|ₘₐₓ is the peak change with MD position x and <dH/dx|ₘₐₓ> is the average over some reasonable span, e.g. over 10% of the effective draw gap in FIG. 14. Roughly equivalent conditions occur when

dH/dx|ₘₐₓ)(W)=dH/d(x/L)|ₘₐₓ)(L/W)⁻¹=β

where β is a constant of a given value. To achieve a certain level of uniformity, the value of β is in part a function process configuration, the material properties and the property from which uniformity is demanded, whether it is caliper uniformity, refractive index uniformity, extent of uniaxial character or some other property resulting from draw. The various properties will in general hold to this rule of thumb to varying degrees over various ranges of draw ratio and L/W ratio. The caliper uniformity and extent of uniaxial character (and through association, the difference between the TD and ND refractive index) are described herein. In particular, β should be under 1, preferably under 0.8 or even 0.3 to be in the truly uniaxial regime. Furthermore, β should be a value of roughly 10 or more to put a typical process in the planar extension regime. This guideline can be used to determine a reasonable single draw gap baseline, from which a corresponding or improved multiple draw gap setting can be designed.

FIGS. 13A, 13B and 14 provide an example MD draw gap scale for a case in which the effective draw gap is 27 cm, so that a film about 13 cm wide has an L/W ratio of 2.1. The shape of these figures can be linearly re-scaled to other physical effective draw gap lengths as needed. For example, the equivalent figures of a film behaving in accord with case C with an initial draw width of 26 cm would then indicate about a 54 cm effective draw gap along their MD position.

An alternative for partitioning the effective draw gap of a baseline single draw gap into a multiple draw gap process can be determined by using the ratio of the average peak change in the Hencky strain to the aspect ratio L/W, that is, the quantity β. Again, consider n draw gaps with effective draw gaps Lⱼ and fast-to-slow roll speed ratios of λⱼ, where j varies from 1 to n. To improve the uniaxial character, the value of β over any given draw gap using the values of Lⱼ and λⱼ and the initial value of W should not exceed the value of β for the single draw gap baseline with the same total effective draw gap length, total draw ratio and initial L/W aspect ratio. The value of β can be discerned such as by using the model of FIG. 13B or a suitable experimental curve derived from progress of cross web fiducial lines marked on the center of the web prior to drawing.

Any number of additional drawing stages may be used. While the length of each of the effective draw gaps may be equal, multiple draw gaps of unequal length can also be used. Moreover, while the MD draw ratio in each of the draw gaps may be equal, multiple draw gaps using different MD draw ratios can also be used. The number of draw gaps for a fixed total length may be practicably limited by the extra, non-effective, length required to heat the film after quenching by previous fast rollers. In general, for a given single gap baseline case, with an actual total draw gap length mapped on to a multiple (n) draw gap case with equal actual total draw gap length, the total effective draw gap for the multiple gaps will be less due to n ineffective draw gap zones. The methods may be generally applied to this view point as well by setting L to the actual draw gap less the ineffective gap lengths. It should also be noted that the various fast and slow rolls are driven to control the cumulative draw ratio along the gaps. Additional idler rolls may be included within these gaps. When there is slippage over the rolls, then the roller contact surface is included in the effective draw gap. When there is no slippage, then the roller contact surface is not included.

Reducing the draw gap in any given drawing stage is also expected to improve the process stability, thereby reducing downweb fluctuations. It is believed that downweb caliper fluctuations are more greatly amplified in longer draw gaps. The amplification may be related to the relative length of the period of the downweb fluctuation and the draw gap.

Another process instability that can be reduced or eliminated with the process of the present disclosure is film wrinkling. It has been observed that long gaps tend to exacerbate this phenomenon. Wrinkling is the out-of-plane oscillation of the film with a typical TD propagation direction. In actual processing, the wrinkles can dynamically walk along the MD from the slow to fast roll. Wrinkling can cause non-uniform heating, process disturbances and final film non-uniformity. A related behavior is curling in which a complete wrinkle is not formed but a bend may occur in the film, especially at the edges. The model results show that increasing the thickness (T) at constant L and W reduces wrinkling and curling by reducing the number or eliminating them completely. At constant W, decreasing the L/T aspect ratio decreases wrinkling and curling. At constant L, decreasing the W/T ratio decreases wrinkling and curling. Holding everything else constant, reducing the MD draw ratio reduces wrinkling and curling. The present disclosure reduces wrinkling and curling by reducing both L and λ_{MD} over any single drawing stage. For example, Cases A′ and C′ show no wrinkling whereas cases A and C do wrinkle. The process of the present disclosure also reduces curling. Case D′ curls less than case D.

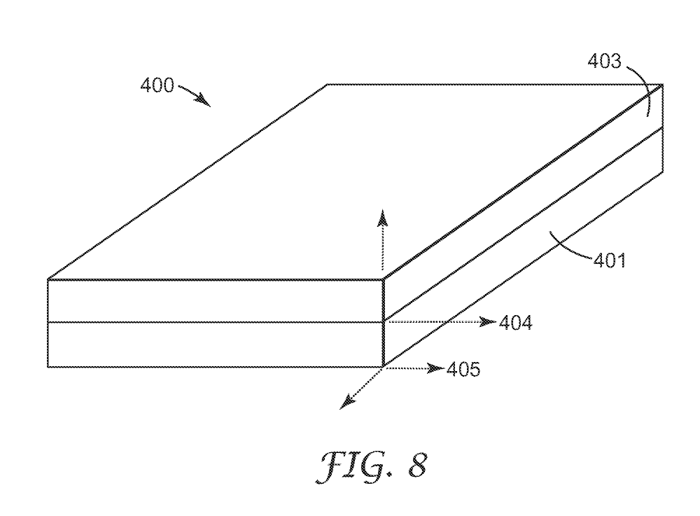

FIG. 8 illustrates an optical film construction 400 in which a first optical film 401, such as a reflective polarizer with a block axis along a direction 405, is combined with a second optical film 403. In one embodiment, a film 20 of the present disclosure is used as first film 401. The second optical film 403 may be another type of optical or non-optical film such as, for example, an absorbing polarizer, with a block axis along a direction 404.

In the construction shown in FIG. 8, the block axis 405 of the reflective polarizing film 401 should be aligned as accurately as possible with the block axis 404 of the dichroic polarizing film 403 to provide acceptable performance for a particular application as, for example, a brightness enhancement polarizer or a display polarizer. Increased mis-alignment of the axes 404, 405 diminishes the gain produced by the laminated construction 400, and makes the laminated construction 400 less useful for display polarizer applications. For example, in an exemplary embodiment of a brightness enhancement polarizer, the angle between the block axes 404, 405 in the construction 400 is less than about ±10°, is more preferably less than about ±5°, and is and even more preferably less than about ±3°.

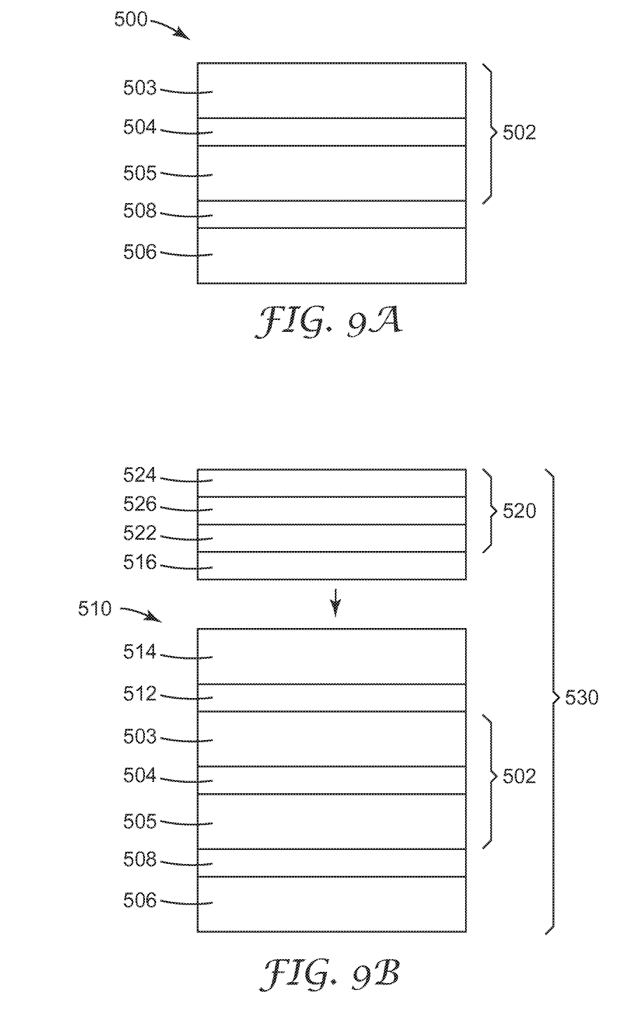

In an embodiment shown in FIG. 9A, a laminate construction 500 includes an absorbing polarizing film 502 with a first protective layer 503. The protective layer 503 may vary widely depending on the intended application, but typically includes a solvent cast cellulose triacetate (TAC) film. The exemplary construction 500 further includes a second protective layer 505, as well as an absorbing polarizer layer 504, such as an iodine-stained polyvinyl alcohol (I₂/PVA). The absorbing polarizing film 502 is laminated or otherwise bonded to or disposed on an optical film reflective polarizer 506 (which can be film 20 as described herein having an MD block axis), for example, with an adhesive layer 508.

FIG. 9B shows an exemplary polarizer compensation structure 510 for an optical display, in which the laminate construction 500 is bonded to an optional birefringent film 514 such as, for example, a compensation film or a retarder film, with an adhesive 512, typically a pressure sensitive adhesive (PSA). In the compensation structure 510, either of the protective layers 503, 505 may optionally be replaced with a birefringent film that is the same or different than the compensation film 514. Such optical films may be used in an optical display 530. In such configurations, the compensation film 514 may be adhered via an adhesive layer 516 to an LCD panel 520 including a first glass layer 522, a second glass layer 524 and a liquid crystal layer 526.

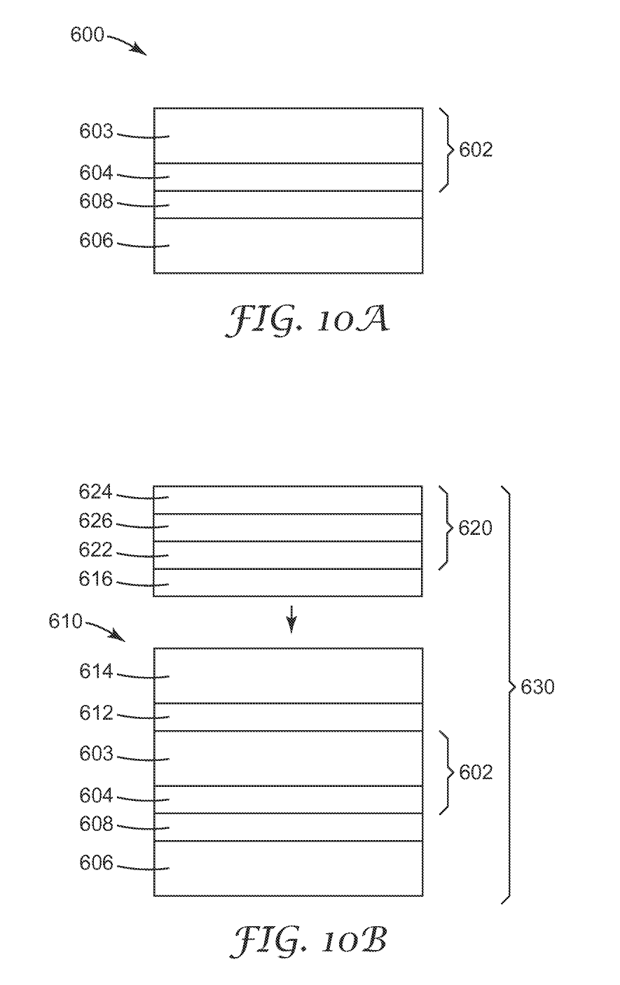

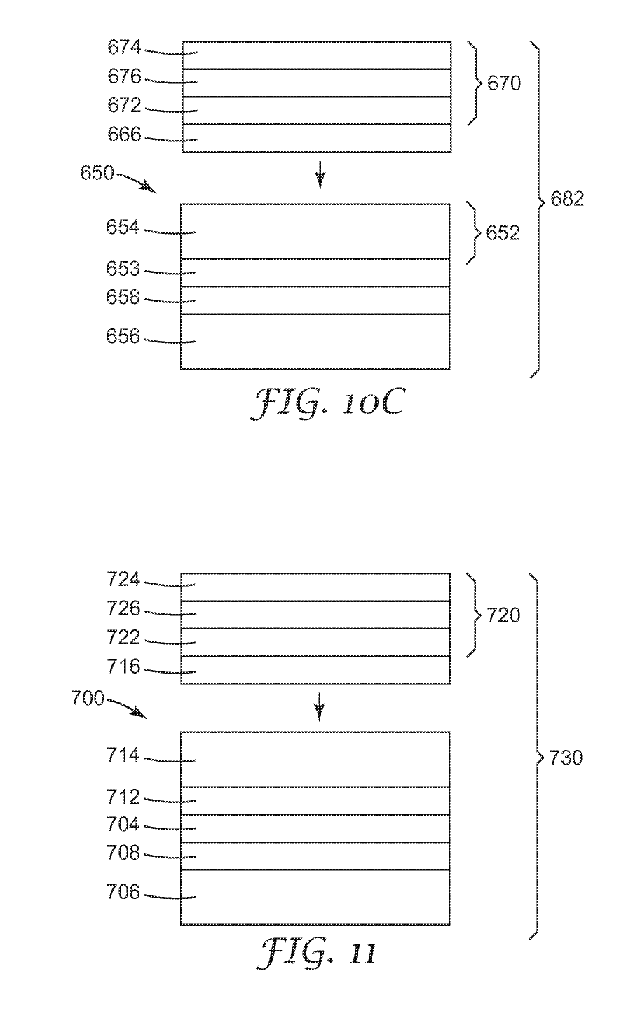

Referring to FIG. 10A, another exemplary laminate construction 600 is shown that includes an absorbing polarizing film 602 having a single protective layer 603 and an absorbing polarizing layer 604, e.g., a I₂/PVA layer. The absorbing polarizing film 602 is bonded to an MD polarization axis optical film reflective polarizer 606 (which can be film 20 as described herein having an MD block axis), for example, with an adhesive layer 608. In this exemplary embodiment, the block axis of the absorbing polarizer is also along the MD. Elimination of either or both of the protective layers adjacent to the absorbing polarizer layer 604 can provide a number of advantages including, for example, reduced thickness, reduced material costs, and reduced environmental impact (solvent cast TAC layers not required).

FIG. 10B shows a polarizer compensation structure 610 for an optical display, in which the laminate construction 600 is bonded to an optional birefringent film 614 such as, for example, a compensation film or a retarder film, with an adhesive 612. In the compensation structure 610, the protective layer 603 may optionally be replaced with a birefringent film that is the same or different than the compensation film 614. Such optical films may be used in an optical display 630. In such configurations, the birefringent film 614 may be adhered via an adhesive layer 616 to an LCD panel 620 including a first glass layer 622, a second glass layer 624 and a liquid crystal layer 626.

FIG. 10C shows another exemplary polarizer compensation structure 650 for an optical display. The compensation structure 650 includes an absorbing polarizing film 652 with a single protective layer 653 and an absorbing polarizer layer 654, such as a I₂/PVA layer. The absorbing polarizing film 652 is bonded to an MD block axis reflective polarizer 656 (which can be film 20 as described herein), for example, with an adhesive layer 658. In the compensation structure 650, the protective layer 653 may optionally be replaced with a compensation film. To form an optical display 682, the absorbing polarizer layer 654 may be adhered via adhesive layer 666 to an LCD panel 670 including a first glass layer 672, a second glass layer 674 and a liquid crystal layer 676.

FIG. 11 shows another exemplary polarizer compensation structure 700 for an optical display, in which the absorbing polarizing film includes a single absorbing (e.g., I₂/PVA) layer 704 without any adjacent protective layers. One major surface of the layer 704 is bonded to an MD block axis optical film reflective polarizer 706 (which can be film 20 as described herein having an MD block axis) such that the block axis of the absorbing polarizer is also along MD. Bonding may be accomplished with an adhesive layer 708. The opposite surface of the layer 704 is bonded to an optional birefringent film 714 such as, for example, a compensation film or a retarder film, with an adhesive 712. Such optical films may be used in an optical display 730. In such exemplary embodiments, the birefringent film 714 may be adhered via adhesive layer 716 to an LCD panel 720 including a first glass layer 722, a second glass layer 724 and a liquid crystal layer 726.

The adhesive layers in FIGS. 9-11 above may vary widely depending on the intended application, but pressure sensitive adhesives and H₂O solutions doped with PVA are expected to be suitable to adhere the I₂/PVA layer directly to the reflective polarizer. Optional surface treatment of either or both of the reflective polarizer film and the absorbing polarizer film using conventional techniques such as, for example, air corona, nitrogen corona, other corona, flame, or a coated primer layer, may also be used alone or in combination with an adhesive to provide or enhance the bond strength between the layers.

In an exemplary embodiment, an optical film comprising a polyester or co-polyester with at least some PET-like or PEN-like moieties, such as terephthalate or naphthalate based sub-units along the chain axis, is formed by drawing the film in one in-plane direction while maintaining or reducing the breadth in the perpendicular in-plane direction to make at least one polyester birefringent and then further heating the drawn film above the initial or final drawing temperatures in a manner that allows at least a further 10% reduction in breadth. In some cases the breadth reduction can be 20% or more.

In another exemplary embodiment, an optical film comprising a polyester or co-polyester with at least some PET-like or PEN-like moieties, such as terephthalate or naphthalate based sub-units along the chain axis, is formed by drawing the film in one in-plane direction while maintaining or reducing the breadth in the perpendicular in-plane direction to make at least one polyester birefringent and then further heating the drawn film above the initial or final drawing temperatures in a manner that maintains or decreases the relative birefringence of at least one birefringent polyester. The relative birefringence obtained in this manner can be under 0.2, 0.15 or even below 0.10.

In still another exemplary embodiment, an optical film comprising a polyester or co-polyester with at least some PET-like or PEN-like moieties, such as terephthalate or naphthalate based sub-units along the chain axis, is formed by drawing the film in one in-plane direction while maintaining or reducing the breadth in the perpendicular in-plane direction to make at least one polyester birefringent and then further heating the drawn film above the initial or final drawing temperatures in a manner that improves the crossweb draw ratio or caliper profile over an edge portion of the film. The edge portion may be on the order of a few to 10 centimeters or more on each side, or encompass 10%, 20% or more of each side of the film.

In yet another exemplary embodiment, an optical film comprising a polyester or co-polyester with at least some PET-like or PEN-like moieties, such as terephthalate or naphthalate based sub-units along the chain axis, is formed by drawing the film in one in-plane direction while maintaining or reducing the breadth in the perpendicular in-plane direction to make at least one polyester birefringent so that the refractive index for light polarized along the draw direction is below a critical value that allows for breadth reduction in a further heated step.

If the film is drawn along MD, then the breadth is the TD direction and vice versa. In exemplary embodiments, the optical film can comprise a multi-layer film with alternating layers of two different materials, a multi-layer optical film with three or more layers of different materials in at least some type of repeating pattern, a continuous/disperse blend or bi-continuous blend with a continuous polyester phase, or any combination of these. Particularly useful examples of such polyesters include PET, PEN and the coPENs which are random or block co-polymers of intermediate chemical composition between PET and PEN.

The drawing conditions that allow the breadth reduction upon orientation depend on the processing temperature history, strain rate history, draw ratios, molecular weights (or IV of the resin) and the like. Typically, it is desired that the film be drawn sufficiently to initiate strain-induced crystallization but not so much as to cause high levels of crystallinity. For exemplary effective draws near the glass transition temperature, the draw ratio typically is under 4, more typically under 3.5, or even 3.0 or less. Typical temperatures are within 10 degrees C. above the glass transition temperature for typical initial draw rates of 0.1 sec⁻¹ or more. For higher temperatures, higher rates are typically used to maintain the same level of effective drawing. Alternatively, higher draw ratios may be allowed. The level of breadth reduction for a film as a function of orientation in a continuous phase may also be altered by the extent and nature of a dispersed or bi-continuous phase.

Another method for determining the level of draw is to measure the effectiveness of that draw on the resulting refractive indices. Above a critical draw index for a given polyester resin, the breadth reduction becomes slight, for example below 10%. Below this critical draw index, significant breadth reduction can occur in a subsequent step, given sufficient time, heating and relaxation of constraints. In many cases, the relative birefringence can also be reduced with the breadth reduction step. For a coPEN comprising 90% PEN-like moieties and 10% PET-like moieties, the critical draw index at 632.8 nm is between 1.77 and 1.81. A best estimate is about 1.78. The critical draw index for PEN is less than 1.79 and probably similar to the value for the 90/10 coPEN. A rough estimate for PET is between 1.65 and 1.68. As a first approximation, coPEN values can be estimated as roughly increasing from the PET values to the PEN values as the coPEN increasingly becomes more like PEN in chemical composition. However, since the level of crystallinity at a given draw index may impact the ability for structural re-arrangement, it may be expected that coPEN critical index values may be higher than these first approximations, as may be indicated from the comparison between the coPEN 90/10 and pure PEN estimates. In general, critical values can be found by heat setting drawn samples of measured index values mounted to provide a large L/W ratio where L is along the direction of draw, and observing the cross-draw width reduction after heat setting. Finally, it should be noted that the critical values may change with severe changes in temperature, such as by heat setting at temperatures near the melting point.

An L.O. can be particularly useful in achieving such drawing conditions while maintaining a reasonably uniform draw ratio along the stretching direction (MDDR in the case of an L.O.). Cross-drawn films, e.g. as drawn in a tenter or a batch stretching device, may be prone to more draw ratio non-uniformities along the stretching direction (TDDR in these case) and thus more product non-uniformities due to cross-web temperature variations and the like. Thus, a particularly useful process uses an L.O. to provide at least the initial drawing step prior to breadth reduction.

The breadth reduction step is accomplished in a manner so that the film can pull-in across its breadth perpendicular to the direction of the first drawing step. When the breadth reduction step is accomplished across a draw gap of an L.O., the LAW ratio is important in controlling the extent and uniformity of the breadth reduction. An L/W ratio of at least 1 is typically desired. Values of 5, 10 or more can be used. It may be useful to use the lowest allowable LAW that achieves the desired breadth reduction to minimize flutter and wrinkling. The temperature and time are preferably of sufficient amount and extent to allow the strain recoil in the process step. Typical conditions for the breadth reduction step comprise heating the film above the glass transition temperature of each continuous phase material in the construction for at least one second. More typically, the heating is to at least the average temperature of the drawing step for at least the time used to accomplish the draw step. In other cases, the temperature of the film is more than 15 degrees C. above the glass transition temperature of each continuous phase material in the construction for 1, 5, 15, 30 seconds or more.

The breadth reduction step may result in a leveling of the thickness due to uneven neck down during the first drawing step. Likewise, a more level distribution of the cross-breadth draw ratio (e.g. TDDR for a film drawn along MD) across the breadth of the film may be achieved as well as a more consistent extent of uniaxial character across the film. In this manner, a more uniform film can be formed. Thus, in one embodiment, the disclosure describes a low draw ratio process with additional heat setting to create breadth reduction and improved uniaxial character regardless of the stretch direction.

The breadth reduction step may also result in an increase in the haze level. Generally, the closer to the critical index, the less the haze increase. In some applications, the level of heat treatment with its reduction in relative birefringence can be balanced against increases in haze as a function of the use of the film so formed for a given optical application.

The following examples include exemplary materials and processing conditions in accordance with different embodiments of the disclosure. The examples are not intended to limit the disclosure but rather are provided to facilitate an understanding of the invention as well as to provide examples of materials particularly suited for use in accordance with the various above-described embodiments.

### EXAMPLE 1

### Modeling of the Multiple Draw Gap

Modeling data were obtained from the finite element method (FEM), using the general-purpose finite element analysis (FEA) program ABAQUS™, a product of ABAQUS, Inc. of Providence, R.I. The finite element method is a numerical technique for solving partial differential equations. Any commercial or proprietary FEA program capable of handling geometric, material, and contact nonlinearities could be used to develop similar models. Examples of alternative commercial programs include ANSYS®, a product of ANSYS, Inc. of Canonsburg, Pa.; and MARC™, a product of MSC Software Corporation of Santa Ana, Calif.

For a typical draw gap scenario, the model consisted of the driven inlet roll 102/Dᵢ, the driven outlet roll 106/Dₒ, and the polymer web 20. Dimensional parameters included the diameters of the inlet and outlet rolls (Øᵢ and Øₒ, respectively), the distance separating the axes of the two rolls (L), and the wrap angle of the web over the inlet and outlet rolls (θᵢ and θₒ, respectively). In the embodiment shown in FIG. 3C, the wrap angle of the web over the inlet and outlet rolls is about 135°. In the embodiment shown in FIG. 3D, the wrap angle of the web over the inlet and outlet rolls is about 90°. In addition, the initial width of the web (Wᵢ), and the initial cross-web thickness profile of the web (tᵢ(x)) were specified. A half-symmetric model was used.

The inlet and outlet rolls were assumed to be driven at the constant rotational speeds ωᵢ and ωₒ, respectively. The ratio of the inlet to outlet rotational speeds defines the draw ratio. To maintain web tension, the web speed prior to the inlet roll (vᵢ) was assumed to be equal to or just slightly less than the surface velocity of the inlet roll (½ Øᵢ ωᵢ). Likewise, the web speed following the outlet roll (vₒ) was assumed to be equal to or slightly greater than the surface velocity of the outlet roll (½ Øₒ ωₒ).

The incoming web was assumed to be at an initial temperature Tᵢ. A representative temperature profile is illustrated in FIG. 19. The web temperature was assumed to increase linearly from Tᵢ to Tₕ while in the heating zone which starts at a distance Lᵢ from the inlet roll, and continues for the distance Lₕ. The web temperature then remained constant at Tₕ until contacting the outlet roll. The web temperature was then assumed to decrease linearly from Tₕ to Tₒ during the time it was in contact with the cooled outlet roll. The temperature was then held constant at Tₒ.

The web material, for example polyethylene, was modeled using a temperature-dependent, finite strain viscoelastic constitutive model. In particular, a neo-Hookean hyperelasticity model was combined with a Prony series representation of a Maxwell viscoelastic model and the Williams-Landell-Ferry time-temperature shift function. This model accounted for the strain-rate dependencies and temperature-dependencies observed during stretching of polymer films at elevated temperatures. Material constants were derived from fitting to experimental uniaxial and biaxial tension data.

Finite strain shell elements were used to model the web. These elements are capable of representing both the in-plane membrane stiffness of the web, as well as out-of-plane thickness response. The inlet and outlet rolls were modeled as analytical rigid surfaces. Frictional contact between the web and roll surface was modeled using a classical Coulomb friction model. Typically, a value of 0.2 was assumed for the coefficient of friction. A quasi-static solution procedure was used.

For structural mechanics, the relevant equations are derived from the conservation of mass and momentum. The momentum equation, which defines the dynamic state of equilibrium, can be expressed using indicial notation as

$$\frac{\partial {σ}_{ij}}{\partial {x}_{j}} + ρ {B}_{i} = \partial \frac{{\partial }^{2} {u}_{i}}{\partial {t}^{2}}$$

where σᵢⱼ are the components of the stress tensor,
xᵢ are the components of an orthonormal basis,
ρ is the local mass density,
Bᵢ are the components of the body force vector,
uᵢ are the components of the displacement vector, and
t is time.

The continuity equation, which describes the conservation of mass, can be written as

$$\frac{\partial ρ}{\partial t} + \frac{\partial }{\partial {x}_{i}} ( ρ \frac{\partial {u}_{i}}{\partial t} ) = 0$$

The momentum equation defines the point-wise balance between internal reaction forces, externally applied loads, and inertial forces. The continuity equation defines the point-wise relationship between the rate of change of the mass density and the divergence of the mass flow rate.

For a typical dual draw gap scenario, the model consisted of the driven inlet roll (Dᵢ), the driven center roll (D_{c}), the driven outlet roll (Dₒ), and the polymer web 20. Dimensional parameters included the diameters of the inlet, center, and outlet rolls (Øᵢ, Ø_{c}, and Øₒ, respectively), the distance separating the axes of the inlet and center rolls (L₁), the distance separating the axes of the center and outlet rolls (L₂), and the wrap angle of the web over the inlet, center, and outlet rolls (θᵢ, θ_{c}, and θₒ, respectively). In addition, the initial width of the web (Wᵢ), and the initial cross-web thickness profile of the web (tᵢ(x)) were specified. A half-symmetric model was used.

The inlet, center, and outlet rolls were assumed to be driven at the constant rotational speeds ωᵢ, ω_{c}, and ωₒ, respectively. To maintain web tension, the web speed prior to the inlet roll (vᵢ) was assumed to be equal to or just slightly less than the surface velocity of the inlet roll (½ Åᵢ ωᵢ). Likewise, the web speed following the outlet roll (vₒ) was assumed to be equal to or slightly greater than the surface velocity of the outlet roll (½ Øₒ ωₒ).

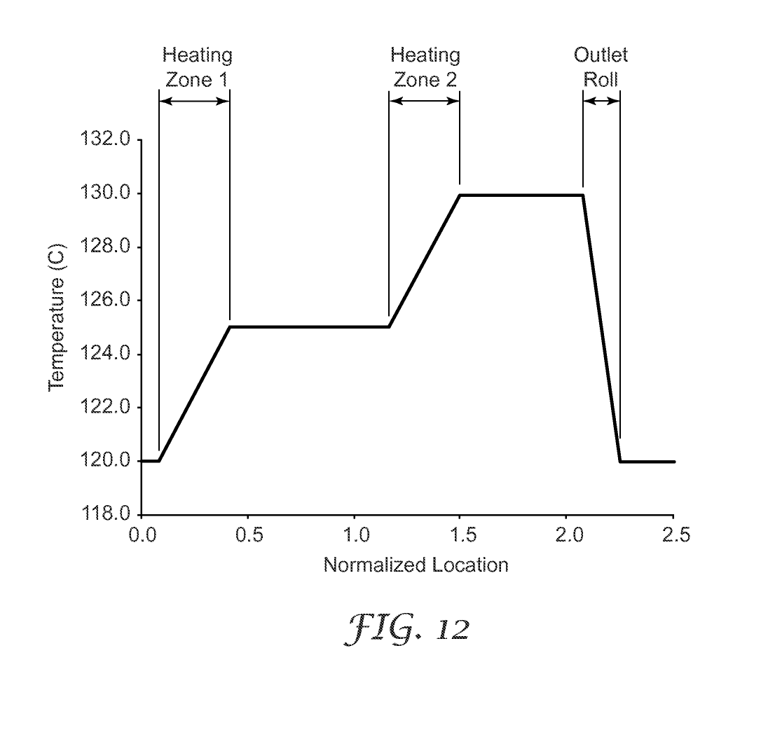

As shown in FIG. 12, the incoming web was assumed to be at an initial temperature Tᵢ. The web temperature was assumed to increase linearly from Tᵢ to Tₕ₁ while in the heating zone of the first draw gap which starts at a distance Lᵢ₁ from the inlet roll and continues for the distance Lₕ₁. The web temperature then remained constant at Tₕ₁ until entering the heating zone of the second draw gap which starts at a distance Lᵢ₂ from the center roll and continues for the distance Lₕ₂. Within this heating zone the web temperature was assumed to increase linearly from Tₕ₁ to Tₕ₂. The web temperature then remained constant at Tₕ₂ until contacting the outlet roll. The web temperature was then assumed to decrease linearly from Tₕ₂ to Tₒ during the time it was in contact with the cooled outlet roll. The temperature was then held constant at Tₒ.

Alternative modeling assumptions could be adopted for simulation of a length orientation process. For example, an elastic-plastic, viscoplastic, or other constitutive model might be used to represent the behavior of the polymer being evaluated. An alternative solution procedure (e.g., dynamic), element formulation (e.g., membrane), or friction model might also be used. Some scenarios may require the use of a complete (i.e., non-symmetric) model, or require simulation of a non-driven (i.e., free-spinning) roll. Finally, alternative temperature profiles could be assumed, or a fully or partially coupled thermal-structural analysis procedure could be used.

### EXAMPLE 2

A precursor of a multilayer optical film was cast as described in U.S. Pat. No. 6,830,713, incorporated herein by reference, and subsequently drawn to various draw ratios in a length orienter. The multilayer cast web comprised the 90/10 coPEN with alternating layers of PMMA in the optical layers. The skin layer comprised a high index birefringent material, a so-called 90/10 coPEN co-polymer with 90 mol % PEN-like moieties and 10% PET-like moieties, allowing direct measurement of the refractive indices.

The film was cast with a non-flat thickness profile in order to compensate for thickness variations with draw processing to obtain a final, relatively flat optical film. The methods of the present disclosure allow for improved thickness (caliper) and property uniformity transversely across the film. Some methods of film casting allow profiled thicknesses that may counter-balance the non-uniformities developed during drawing, e.g. in a length orienter; however, the basic non-uniformity in properties such as refractive index remain. Further improvements in thickness uniformity may be achieved by combining cast thickness profiling with the present methods. Likewise, film results using these combinations, such as those provided in this Example, clearly lie within the intended scope of the present disclosure.

The cast web was drawn in an L.O. to form the drawn precursor optical film, hereafter referred to as the “L.O.ed film.” The L.O.ed film would normally be drawn to a desired MDDR, in this case 3.0, and then further drawn transversely, e.g. in a tenter, to form a multilayer optical mirror film as described by Jonza et. al. in U.S. Pat. No. 5,882,774.

Case 1 is the L.O.-drawn film. Cases 2 through 5 explore the effect of heat setting this film under a variety of conditions. In each Case 2-5, the film was nominally heat set at 175 degrees C over a 2 minute interval in a laboratory stretching device. The device grips the film at distinct clips whose spacing can be adjusted in-plane. Only one-half of the L.O.-drawn film was studied from one TD edge to nearly the center of the film. To facilitate mounting, the films were cut into two pieces across TD, one covering the edge quarter and the other covering the interior quarter nearly up to the film center. The cases were meant to simulate a variety of conditions that could also be accomplished on-line using a variety of processing equipment.

In Case 2, the film was mounted under a very slight initial MD tension so that the TD edges were unconstrained. In Case 3, the film was mounted as in Case 2 and then further drawn over the course of heat setting by a factor of 1.1 to a final draw ratio of approximately 3.3. Case 4 was the analogue to Case 2 in which the film was mounted so that the TD edges were gripped, thus constraining the TDDR to nearly its initial value before heat setting. Case 5 was the analogue to Case 3 in which the film was mounted so that the TD edges were gripped, thus constraining the TDDR to nearly its initial value before heat setting, while the film was further drawn over the course of heat setting by a factor of 1.1 to a final draw ratio of approximately 3.3.

Prior to heat setting, the films were marked with fiducial lines to allow for direct measurement of draw ratio changes with heat setting. In each case, the refractive indices were measured at selected crossweb (TD) positions using a Metricon Prism Coupler equipped with a He—Ne laser for measurement at 632.8 nm as available from Metricon located in Piscataway, N.J., USA. The skin layer with the 90/10 coPEN on the side contacting the slow roll was measured for the index evaluations. The x, y and z directions correspond to the MD, TD and thickness directions in each case.

Case 1 exhibits the general index trends with varying extent of uniaxial character across the film. The edges have a high degree of uniaxial character due to neckdown, while the low L/W ratio constrains the center of the film. In particular, the edge demonstrates a value of U equal to 0.75 with an index mismatch TD to ND of slightly over 0.01 and a relative birefringence of about 0.066. Case 1 is the baseline for each of the other cases.

In each of the Cases 2-5, a significant increase in the MD refractive index is observed ranging from a difference of 0.01 to almost 0.05. The two Cases 3 and 5 with drawing during heat setting provided the greatest increase in MD refractive index. The added increase in index is typical of what is expected with the increase in draw ratio. Case 3 however showed a very small increase in the difference between the TD and ND indices relative to Case 1, while Case 5 showed the greatest differences. The effect on TD/ND index differences of heat setting under TD constraint without further drawing, exemplified by Case 4, is intermediate in result between Cases 2 and 3 (smallest changes) and Case 5 (largest change).

Case 2 shows the result of heat setting unconstrained in TD, except by the action of the MD boundary condition of clip gripping in the laboratory device. In this manner, the TD edges of the heat set film are particularly able to contract along TD to obtain the highest levels of TD strain recovery across the sample. Since Case 2 was accomplished by two pieces cut at the relative position of 0.43 in TD, the edge measurements at relative positions of 0.37, 0.48 and 0.80 showed the highest level of TD strain recovery, in these cases resulting in a reduction (or at least maintenance within experimental error) in the relative birefringence. A very small strain recovery occurs at the edge corresponding to the edge of the L.O.-drawn film, as would be expected from the high value of U. This location also experiences a maintenance or reduction of relative birefringence with heat setting. The affect of TD strain recovery is also present in Case 3. Thus, TD strain recovery during heat setting can improve the extent of uniaxial character after drawing for films drawn along MD. More generally, strain recovery in a second non-drawn in-plane direction can improve the extent of uniaxial character after drawing in a first in-plane direction (e.g. MD strain recovery if drawn in TD).

In each case in Tables 2-5, the film was heat set under mounting conditions providing an L/W ratio of about 0.8. Under these conditions, breadth reduction over 10% was achieved; however the film still substantially deviated from the conditions of a perfectly truly uniaxial draw over major portions of the film.

Considering Case 2 of this Example 2, relative birefringence was reduced at the very edges of the film, either where the film was already very nearly truly uniaxially oriented, i.e. at position 0.5, or where substantial local breadth reduction occurred at positions 3.5, 4.5 and 7.5. These are the edge positions formed by cutting the original film longitudinally before heat treating. A similar situation occurs in Case 3, except that the highly uniaxial edge at position 5 now has a slight increase rather than a decrease in relative birefringence.

Case 2 of this Example also demonstrates an improvement in the TDDR and likewise the caliper or thickness uniformity through the breadth reduction step. As is directly calculable from the U values in Table 2, the TDDR over the initial positions of 0.5, 1.0, 1.5 and 2.0 from the original edge are 0.417, 0.498, 0.519 and 0.554, respectively. Upon further breadth reduction to fractions of their post-drawn width of 0.939, 0.938, 0.906 and 0.875, the final TDDRs become 0.404, 0.467, 0.470 and 0.484, respectively. In this manner, the uniformity of the TDDR (and the thickness profiles) across the width substantially improve. Thus, the breadth reduction step allows the middle portion of the film to further neck down relative to the edge, allowing that middle portion to partially catch up with the neck down achieved by the edge during the previous drawing step.

### LO-Drawn Film:

TABLE 1
Example 2, Case 1

| position | relative | | | | | | |
|---|---|---|---|---|---|---|---|
| from | position | | | | | | |
| edge | from | U (initial | | | n(z) | delta n | relative |
| (cm) | edge | draw) | n(x) | n(y) | (average) | ny − nz | Birefringence |
| 1.27 | 0.05 | 0.75 | 1.7689 | 1.5841 | 1.5714 | 0.0127 | 0.0664 |
| 2.54 | 0.11 | 0.57 | 1.7714 | 1.5850 | 1.5692 | 0.0158 | 0.0813 |
| 3.81 | 0.16 | 0.53 | 1.7753 | 1.5846 | 1.5666 | 0.0181 | 0.0904 |
| 5.08 | 0.21 | 0.47 | 1.7744 | 1.5862 | 1.5661 | 0.0201 | 0.1014 |
| 6.35 | 0.27 | 0.43 | 1.7726 | 1.5878 | 1.5656 | 0.0222 | 0.1133 |
| 7.62 | 0.32 | 0.39 | 1.7722 | 1.5894 | 1.5645 | 0.0249 | 0.1275 |
| 8.89 | 0.37 | 0.33 | 1.7728 | 1.5914 | 1.5633 | 0.0281 | 0.1438 |
| 10.16 | 0.43 | 0.27 | 1.7716 | 1.5921 | 1.5625 | 0.0296 | 0.1523 |
| 11.43 | 0.48 | 0.25 | 1.7716 | 1.5951 | 1.5624 | 0.0328 | 0.1698 |
| 12.70 | 0.53 | 0.23 | 1.7708 | 1.5935 | 1.5621 | 0.0314 | 0.1629 |
| 13.97 | 0.59 | 0.24 | 1.7707 | 1.5935 | 1.5619 | 0.0316 | 0.1637 |
| 15.24 | 0.64 | 0.24 | 1.7720 | 1.5935 | 1.5615 | 0.0320 | 0.1648 |
| 16.51 | 0.69 | 0.23 | 1.7717 | 1.5931 | 1.5622 | 0.0310 | 0.1595 |
| 17.78 | 0.75 | 0.22 | 1.7696 | 1.5938 | 1.5621 | 0.0317 | 0.1654 |
| 19.05 | 0.80 | 0.22 | 1.7698 | 1.5935 | 1.5619 | 0.0316 | 0.1645 |

### Unconstrained Heat Set

TABLE 2
Example 2, Case 2

| position | relative | | | | | | | | |
|---|---|---|---|---|---|---|---|---|---|
| from | position | U | | | | | | Change | Ratio |
| edge | from | (initial | | | n(z) | delta n | relative | relative | TDDR, final:TDDR, |
| (cm) | edge | draw) | n(x) | n(y) | (average) | ny − nz | Birefringence | Birefringence | Initial |
| 1.27 | 0.05 | 0.75 | 1.7856 | 1.5850 | 1.5717 | 0.0134 | 0.0644 | −0.002 | 0.969 |
| 2.54 | 0.11 | 0.57 | 1.7851 | 1.5875 | 1.5671 | 0.0204 | 0.0984 | 0.017 | 0.938 |
| 3.81 | 0.16 | 0.53 | 1.7805 | 1.5908 | 1.5658 | 0.0250 | 0.1236 | 0.033 | 0.906 |
| 5.08 | 0.21 | 0.47 | 1.7823 | 1.5935 | 1.5661 | 0.0274 | 0.1355 | 0.034 | 0.875 |
| 6.35 | 0.27 | 0.43 | 1.7875 | 1.5940 | 1.5653 | 0.0287 | 0.1381 | 0.025 | 0.875 |
| 7.62 | 0.32 | 0.39 | | 1.5940 | 1.5659 | 0.0281 | | | 0.844 |
| 8.89 | 0.37 | 0.33 | 1.7711 | 1.5915 | 1.5648 | 0.0267 | 0.1384 | −0.005 | 0.781 |
| 10.16 | 0.43 | 0.27 | | | | | | | |
| 11.43 | 0.48 | 0.25 | 1.7878 | 1.5961 | 1.5621 | 0.0341 | 0.1631 | −0.007 | 0.813 |
| 12.70 | 0.53 | 0.23 | 1.7826 | 1.5993 | 1.5603 | 0.0391 | 0.1925 | 0.030 | 0.828 |
| 13.97 | 0.59 | 0.24 | 1.7851 | 1.6017 | 1.5606 | 0.0411 | 0.2017 | 0.038 | 0.828 |
| 15.24 | 0.64 | 0.24 | 1.7865 | 1.6010 | 1.5592 | 0.0418 | 0.2025 | 0.038 | 0.844 |
| 16.51 | 0.69 | 0.23 | 1.7913 | | | | | | 0.828 |
| 17.78 | 0.75 | 0.22 | 1.7955 | 1.5989 | 1.5585 | 0.0404 | 0.1863 | 0.021 | 0.781 |
| 19.05 | 0.80 | 0.22 | 1.7951 | 1.5938 | 1.5600 | 0.0338 | 0.1549 | −0.010 | 0.719 |

### Unconstrained and Drawn during Heat Set

TABLE 3
Example 2, Case 3

| position | relative | | | | | | |
|---|---|---|---|---|---|---|---|
| from | position | | | | | | |
| edge | from | U (initial | | | n(z) | relative | delta n |
| (cm) | edge | draw) | n(x) | n(y) | (average) | Birefringence | ny − nz |
| 1.27 | 0.05 | 0.75 | 1.8040 | 1.5848 | 1.5690 | 0.0698 | 0.0158 |
| 2.54 | 0.11 | 0.57 | 1.7980 | 1.5873 | 1.5663 | 0.0949 | 0.0210 |
| 3.81 | 0.16 | 0.53 | 1.7955 | 1.5889 | 1.5659 | 0.1055 | 0.0230 |
| 5.08 | 0.21 | 0.47 | 1.7976 | 1.5894 | 1.5646 | 0.1124 | 0.0248 |
| 6.35 | 0.27 | 0.43 | 1.7971 | 1.5905 | 1.5645 | 0.1184 | 0.0260 |
| 7.62 | 0.32 | 0.39 | 1.8017 | 1.5885 | 1.5621 | 0.1166 | 0.0264 |
| 8.89 | 0.37 | 0.33 | 1.8046 | 1.5862 | 1.5631 | 0.1007 | 0.0232 |
| 10.16 | 0.43 | 0.27 | | | | | |
| 11.43 | 0.48 | 0.25 | 1.7878 | 1.5889 | 1.5621 | 0.1265 | 0.0268 |
| 12.70 | 0.53 | 0.23 | 1.7855 | 1.5929 | 1.5608 | 0.1538 | 0.0321 |
| 13.97 | 0.59 | 0.24 | 1.7935 | 1.5963 | 1.5592 | 0.1720 | 0.0371 |
| 15.24 | 0.64 | 0.24 | 1.7928 | 1.5995 | 1.5591 | 0.1892 | 0.0404 |
| 16.51 | 0.69 | 0.23 | 1.7945 | 1.5970 | 1.5593 | 0.1743 | 0.0377 |
| 17.78 | 0.75 | 0.22 | 1.7958 | 1.5940 | 1.5598 | 0.1562 | 0.0342 |
| 19.05 | 0.80 | 0.22 | 1.7928 | 1.5896 | 1.5627 | 0.1242 | 0.0269 |

### Constrained Heat Set

TABLE 4
Example 2, Case 4

| position | | | | | |
|---|---|---|---|---|---|
| from | U | | | | |
| edge | (initial | | | n(z) | delta n |
| (cm) | draw) | n(x) | n(y) | (average) | ny − nz |
| 1.27 | 0.75 | 1.7939 | 1.5951 | 1.5665 | 0.0286 |
| 2.54 | 0.57 | 1.7928 | 1.5991 | 1.5665 | 0.0326 |
| 3.81 | 0.53 | 1.7987 | 1.5991 | 1.5559 | 0.0432 |
| 5.08 | 0.47 | 1.7941 | 1.6012 | 1.5578 | 0.0435 |
| 6.35 | 0.43 | 1.7837 | 1.6031 | 1.5606 | 0.0425 |
| 7.62 | 0.39 | 1.7873 | 1.6049 | 1.5582 | 0.0467 |
| 8.89 | 0.33 | 1.7980 | 1.6054 | 1.5515 | 0.0539 |
| 10.16 | 0.27 | 1.7961 | 1.6047 | 1.5520 | 0.0527 |
| 11.43 | 0.25 | 1.8011 | 1.6024 | 1.5474 | 0.0550 |
| 12.70 | 0.23 | 1.7934 | 1.6107 | 1.5472 | 0.0635 |
| 13.97 | 0.24 | 1.7928 | 1.6129 | 1.5447 | 0.0683 |
| 15.24 | 0.24 | 1.7995 | 1.6152 | 1.5440 | 0.0713 |
| 16.51 | 0.23 | 1.7903 | 1.6138 | 1.5473 | 0.0665 |
| 17.78 | 0.22 | 1.7897 | 1.6129 | 1.5474 | 0.0655 |
| 19.05 | 0.22 | 1.7908 | 1.6142 | 1.5469 | 0.0674 |

### Constrained and Drawn during Heat Set

TABLE 5
Example 2, Case 5

| position | relative | | | | | |
|---|---|---|---|---|---|---|
| from | position | U | | | | |
| edge | from | (initial | | | n(z) | delta n |
| (cm) | edge | draw) | n(x) | n(y) | (average) | ny − nz |
| 1.27 | 0.05 | 0.75 | 1.8074 | 1.5956 | 1.5506 | 0.0451 |
| 2.54 | 0.11 | 0.57 | 1.8040 | 1.5975 | 1.5534 | 0.0441 |
| 3.81 | 0.16 | 0.53 | 1.8006 | 1.5984 | 1.5534 | 0.0450 |
| 5.08 | 0.21 | 0.47 | 1.7961 | 1.6012 | 1.5549 | 0.0463 |
| 6.35 | 0.27 | 0.43 | 1.8016 | 1.6023 | 1.5495 | 0.0529 |
| 7.62 | 0.32 | 0.39 | 1.8024 | 1.6035 | 1.5478 | 0.0557 |
| 8.89 | 0.37 | 0.33 | 1.7981 | 1.6042 | 1.5488 | 0.0555 |
| 10.16 | 0.43 | 0.27 | 1.7996 | 1.6037 | 1.5492 | 0.0545 |
| 11.43 | 0.48 | 0.25 | 1.8129 | 1.6005 | 1.5446 | 0.0559 |
| 12.70 | 0.53 | 0.23 | 1.7919 | 1.6091 | 1.5499 | 0.0593 |
| 13.97 | 0.59 | 0.24 | 1.7925 | 1.6122 | 1.5474 | 0.0648 |
| 15.24 | 0.64 | 0.24 | 1.7925 | 1.6126 | 1.5463 | 0.0663 |
| 16.51 | 0.69 | 0.23 | 1.7942 | 1.6129 | 1.5452 | 0.0677 |
| 17.78 | 0.75 | 0.22 | 1.7955 | 1.6122 | 1.5447 | 0.0675 |
| 19.05 | 0.80 | 0.22 | 1.7938 | 1.6138 | 1.5452 | 0.0686 |

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

What is claimed is:

1. A method of forming an optical film, the method comprising:
stretching a polymer film in first draw gap of a first length along a machine direction, at a first draw ratio; and
further stretching the polymer film in second draw gap along a machine direction, wherein the step of stretching in the first draw gap is isolated from the step of stretching in the second draw gap.

2. The method of claim 1 wherein the isolation is accomplished by quenching the polymer film.

3. The method of claim 1 wherein the isolation is accomplished by a roll positioned between the first draw gap and the second draw gap.

4. The method of claim 1 wherein the optical film is substantially uniaxial.

5. The method of claim 1 wherein the stretching step is performed using a length orienter.

6. The method of claim 1 further comprising heat setting the polymer film.

7. The method of claim 1 wherein the second draw gap has a second length, and the second length is equal to the first length.

8. The method of claim 1 wherein the second draw gap has a second length, and the second length is not equal to the first length.

9. The method of claim 1 wherein the step of stretching the polymer film in the second draw gap comprises stretching the polymer film at a second draw ratio, and the second draw ratio is equal to the first draw ratio.

10. The method of claim 1 wherein the step of stretching the polymer film in the second draw gap comprises stretching the polymer film at a second draw ratio, and the second draw ratio is not equal to the first draw ratio.

11. The method of claim 1 wherein
the step of stretching the polymer film in the first draw gap comprises stretching the polymer film between a first slow roll and a first fast roll; and
the step of stretching the polymer film in the second draw gap comprises stretching the polymer film between a second slow roll and a second fast roll.

12. The method of claim 11 wherein a center roll acts as both the first fast roll and the second slow roll.

13. The method of claim 11 further comprising an intervening isolating roll between the first fast roll and the second slow roll.

14. The method of claim 1 wherein
the step of stretching the polymer film in the first draw gap comprises stretching the polymer film at a first average temperature; and
the step of stretching the polymer film in the second draw gap comprises stretching the polymer film at a second average temperature,
wherein the second average temperature is greater than the first average temperature.

15. The method of claim 1 wherein at least one of the first draw ratio or the second draw ratio is greater than about 1.5 and the optical film has an extent of uniaxial character U greater than about 0.7.

16. The method of claim 1 further comprising stretching the polymer film in n number of draw gaps, wherein the first draw ratio λ* is set according to an equation
λ_{final}=(λ*)ⁿ
where a final desired draw ratio is λ_{final}.

17. The method of claim 1 further comprising stretching the polymer film in n number of draw gaps, wherein the first length Lⱼ is set according to an equation
Lⱼ=L[(λ*)^{(-1/2)}−1](λ*)^{[-(k-1)/2}]/[(λ*)^{(-n/2)}−1]
where L is a total of length of a sum of effective draw gaps, the first draw ratio is λ*, and a number of fast rolls is k.
